(19) United States
(12) Patent Application Publication
(10) Pub. No.: US 2004/0220829 A1
(43) Pub. Date: Nov. 4, 2004

(54) Distributed system and method for managing communication among healthcare providers, patients and third parties

(76) Inventors: Ofir Baharav, Palo Alto, CA (US); David R. Weinstein, Danville, CA (US); Assaf Morag, Palo Alto, CA (US); Gary Gannot, Kensington, CA (US)

Correspondence Address: GLENN PATENT GROUP, 3475 EDISON WAY, SUITE L, MENLO PARK, CA, 94025, US

(21) Appl. No.: 10/359,414

(22) Filed: Feb. 5, 2003

Related U.S. Application Data
(63) Continuation-in-part of application No. 09/394,341, filed on Sep. 13, 1999.
(63) Continuation-in-part of application No. 09/937,364, filed on Sep. 21, 2001.
Application No. 09/937,364 is a 371 of international application No. PCT/US00/07716, filed on Mar. 22, 2000.
(60) Provisional application No. 60/354,836, filed on Feb. 5, 2002.
(60) Provisional application No. 60/125,461, filed on Mar. 22, 1999.

(51) Int. Cl. G06F 17/60

(52) U.S. Cl. 705/2

(57) ABSTRACT

In a distributed system for managing communication among healthcare providers, patients and third parties, users interact via clients connected to a server. Modules resident on the server provide functions that facilitate efficient communication among all the parties. System functions include: an online consultation platform that provides an interactive patient interview, produces a succinct message to the provider, and a prompt response to the patient's query; online prescribing and refills and transmission of the prescription; streamlined messaging between patient and provider employs via specialized message types; practice and workflow management for the provider that includes specialized message types, customizable routing, and role-based permissions; customizable practice web sites for registered providers, wherein patients can visit to access online services; broadcast of patient education materials customized and automatically distributed to targeted patient groups; and integrated charging and collections, determination of eligibility for coverage, and reimbursement.

### CROSS-REFERENCE TO RELATED APPLICATIONS

This application claims benefit of U.S. Provisional Patent Application Ser. No. 60/354,836, filed Feb. 5, 2002; and is a Continuation-in-part of U.S. patent application Ser. No. 09/394,341, filed Sep. 13, 1999, and U.S. patent application Ser. No. 09/937,364, filed Sep. 21, 2001, which claims priority from PCT Application No. US00/07716, filed Mar. 22, 2000, which claims benefit of U.S. Provisional Patent Application Ser. No. 60/125,461, filed Mar. 22, 1999.

### BACKGROUND OF THE INVENTION

### FIELD OF THE INVENTION

The invention generally relates to the field of electronic messaging. More particularly, the invention relates to a distributed system and method for managing communication between patients, healthcare providers and third parties, such as payors or pharmacies.

### TECHNICAL BACKGROUND

In the United States today, over 70% of all adults have Internet access. Internet 9: the media and entertainment world of online consumers, ARBITRON Research Report, (September 2002). Furthermore, the vast majority of those having Internet access would like to be able to communicate with their health care provider online. Patient/physician online communication: many patients want it, would pay for it, and it would influence their choice of doctors and health plans, Harris Interactive Health Care News (Apr. 10, 2002). It has been reported that unstructured email communication between patient and physician, triaged by nurses, has been of value to patients. C. Moyer, D. Stern, K. Dobias, Bridging the electronic divide: patient and provider perspectives an e-mail communication in primary care, Am J Manag Care, v.8, pp, 427-433 (2002). Nevertheless, healthcare, as a whole, has been slow to adopt the Internet as a method for consumer-oriented communications and transactions.

A number of issues associated with email communication between patient and healthcare provider limit its usefulness as an alternative to the office visits for non-urgent problems. E-mail cannot satisfy the stringent security measures required by the Health Insurance Portability and Accountability Act of 1996 (HIPAA). The lack of a structured message format often renders it difficult for the healthcare provider to obtain the information necessary to address a patient's problem adequately, often requiring several rounds of messaging. Such delays waste both the provider's and the patient's time, and may pose a serious hazard to the patient if it takes the provider too long to ascertain that the patient needs urgent care. Lack of provider reimbursement is a significant barrier to widespread adoption of online communication between provider and patient. Many third-party payors are unwilling to reimburse providers for online consultations, and the small amount patients are willing to pay is unlikely to provide providers incentive to adopt online communication on a widespread basis. There are also concerns about provider liability and message volume.

A co-pending application of the assignee of the present invention, A. Morag, G. Gannot, O. Baharav, A message and program system supporting communication, U.S. patent application Ser. No. 09/394,341 (Sep. 13, 1999), describes a method and system for messaging that facilitates communication between healthcare providers, such as physicians, and their patients. Messaging between patient and healthcare provider is mediated by a workflow engine housed on a server. Using a message wizard operating on a patient-operated computer, the patient creates a query for their healthcare provider. By providing a wizard to generate patient queries, the system assures that the patient query will provide the provider with a concise, clear and complete description of the patient's condition that can be read quickly, and responded to promptly. The workflow engine attaches the patient's medical profile to the query, minimizing the possibility that the provider will need to refer to the patient's record or chart to respond to the query. The system also allows the provider to supply a prescription with the response query response. The prescription, embedded in the provider's response to the patient allows the patient to decide whether or not to order the prescription, specifies the desired pharmacy, brand, and delivery options. After the patient provides the necessary input, a prescription message is directed to the pharmacy. The workflow engine also serves to mediate the billing process and maintain a log of messages between patient and provider, which becomes part of the patient profile.

Another co-pending application of the assignee of the present invention, D. Weinstein and R. Reiss, Method and apparatus for medical covering group request processing review and management, U.S. patent application Ser. No. 09/937,364 (Sep. 21, 2001), provides a system and method whereby any member of a medical covering group, a group of physicians or other health care providers who provide coverage for each other's practices, performs such tasks as authorizing prescriptions and refills, authorizing and responding to referrals, and authorizing lab tests and reviewing lab results. Group members may attend to these tasks either for their own practices or for that of any member of the covering group. Using a variety of interactive tools, members of the covering group review prioritized lists of outstanding administrative tasks, either theirs, or those of other group members, and dispose of the requests as appropriate. Thus, Weinstein, et al., provides a single optimized process of communication, compliance review, decision-making and progress monitoring for individual providers and the covering group they belong to, resulting in improved communication and patient care, reduced administrative overhead and a corresponding increase in revenue.

It would be a great advance to provide patient/provider messaging that incorporates a feature set designed specifically for healthcare, including integrated eligibility checking, fee and co-pay collection, electronic prescribing, coding, electronic referrals, and messaging forms designed to facilitate appointment scheduling, prescription refills, reporting test results and other routine transactions; it would be advantageous to provide a HIPAA-capable system, incorporating secure servers, firewalls, encryption and a complete audit trail, that can be implemented quickly and easily by providers and healthcare organizations without significant infrastructure investments. It would also be an advantage to provide the online consultations with health care providers that included scripted interviews and questionnaires. Finally, it would be a significant advance to provide patients with medically reviewed healthcare information, such as preventive health information, self-care and preventive care information, chronic care management, and customizable, targetable patient newsletters.

### SUMMARY OF THE INVENTION

The invention provides a distributed system and method for managing communication among healthcare providers, patients and third parties. Providers, patients and third parties such as pharmacists or insurance carriers interact with each other via clients connected to an application server. Software modules resident on the server provide a variety of services that facilitate efficient communication among all the parties.

Among the services are:

An online consultation platform that guides the patient through an interactive interview, builds a succinct message to the provider, and furnishes the provider with an array of tools to efficiently reply to the patient;

Online Prescriptions. An electronic prescription service facilitates writing and filling of new prescriptions and authorization of refills and renewals. Providers, staff, and patients can instantly transmit authorized prescriptions to virtually any pharmacy in the United States chosen by the patient without resorting to “phoning in” the prescription, automatically screen for drug interactions, and ensure formulary compliance. The electronic prescription service advantageously includes the patient in the prescribing process, providing a capability wherein the patient makes the final decision whether or not to fill the prescription and directs the prescription to the pharmacy of his or her choice;

Streamlined messaging between patient and provider employs specialized message types for communications such as appointment setting, prescription refills, referrals, test results and appointment reminders. Easily established message routing simplifies workflow for provider and staff;

Practice and workflow management for the provider: provider and staff collaborate effectively and efficiently using specialized message types, customizable message routing, and role-based permissions.

A web site for the provider: Registered providers can take advantage of an automatically generated, customizable practice web site. Patients can visit provider web sites to access online services;

Broadcast of patient education materials: patient newsletters, and preventive and self-care information can be customized and automatically distributed to targeted patient groups; and

Integrated charging and collections, determination of eligibility for coverage, and reimbursement.

### BRIEF DESCRIPTION OF THE DRAWINGS

FIG. 1 provides a block diagram of a distributed system for managing communication among healthcare providers, patients and third parties according to the invention;

FIG. 2 provides a diagram of the server-side architecture of the system of FIG. 1 according to the invention;

FIG. 3 shows a sign-on screen from a user interface to the system of FIG. 1 according to the invention;

FIG. 4 shows a first view of a patient message center from the user interface of FIG. 3 according to the invention FIG. 5 provides a second view of the patient message center of FIG. 4 according to the invention;

FIG. 6 shows a patient message center from the user interface of FIG. 3 according to the invention;

FIG. 7 shows a list of a selected patient's personal healthcare providers from the user interface of FIG. 3 according to the invention;

FIG. 8 shows a patient health profile according to the invention;

FIG. 9 provides a first view of a scripted interview for an online consultation from the user interface of FIG. 3 according to the invention;

FIG. 10 provides a second view of the scripted interview of FIG. 8 according to the invention;

FIG. 11 illustrates a screen providing drop-down menus for selecting patient and provider to fill in fields of a structured message template from the user interface of FIG. 3 according to the invention;

FIG. 12 provides a flow diagram of a process for generating a message using structured message templates from the user interface of FIG. 3 according to the invention;

FIG. 13 shows a structured message template for an appointment request from the user interface of FIG. 3 according to the invention;

FIG. 14 provides an exemplary prescription renewal request from the user interface of FIG. 3 according to the invention;

FIG. 15 shows a structured message template for requesting lab results according to the invention;

FIG. 16 provides a first view of a structured message template for requesting a provider referral from the user interface of FIG. 3 according to the invention;

FIG. 17 provides a second view of the message template of FIG. 16 according to the invention;

FIG. 18 illustrates a menu of additional structured message types from the user interface of FIG. 3 according to the invention;

FIG. 19 shows a structured template for a patient billing inquiry from the user interface of FIG. 3 according to the invention;

FIG. 20 shows a billing inquiry message generated from the structured template of FIG. 19 according to the invention;

FIG. 21 shows a structured template for a patient insurance inquiry from the user interface of FIG. 3 according to the invention;

FIG. 22 provides a first view of a provider message center from the user interface of FIG. 3 according to the invention;

FIG. 23 provides a second view of the provider message center of FIG. 22 according to the invention;

FIG. 24 illustrates a provider message center from the user interface of FIG. 3 according to the invention;

FIG. 25 shows a view of a provider web page from the user interface of FIG. 3 according to the invention;

FIG. 26 illustrates a provider view of the online consultation of FIGS. 9 and 10 according to the invention;

FIG. 27 shows a structured template for replying to an online consultation from the user interface of FIG. 3 according to the invention;

FIG. 28 shows a structured message template for communication of test results to a patient from the user interface of FIG. 3 according to the invention;

FIG. 29 shows a message resulting from the structured message template of FIG. 28 according to the invention;

FIG. 30 shows a form for configuring group and member settings from the user interface of FIG. 3 according to the invention;

FIG. 31 shows a form for setting a fee for a message type from the user interface of FIG. 3 according to the invention;

FIG. 32 shows a form for accessing individual member settings from the user interface of FIG. 3 according to the invention;

FIG. 33 shows a form for configuring settings for a selected provider from the user interface of FIG. 3 according to the invention;

FIG. 34 shows a form for configuring settings for a selected staff member from the user interface of FIG. 3 according to the invention;

FIG. 35 illustrates a form for setting message options and routing from the user interface of FIG. 3 according to the invention;

FIG. 36 shows a form for configuring broadcast activities from the user interface of FIG. 3 according to the invention;

FIG. 37 shows a view of a provider newsletter from the user interface of FIG. 3 according to the invention;

FIG. 38 shows an interactive form for editing the provider newsletter of FIG. 34 according to the invention;

FIGS. 39 through 42 show forms for configuring settings for broadcasting preventive care programs to selected groups of patients according to the invention;

FIG. 43 shows a patient's view of an audit trail of the patient's health care record according to the invention; and

FIG. 44 shows a provider's view of the audit trail of FIG. 40 according to the invention.

### DETAILED DESCRIPTION

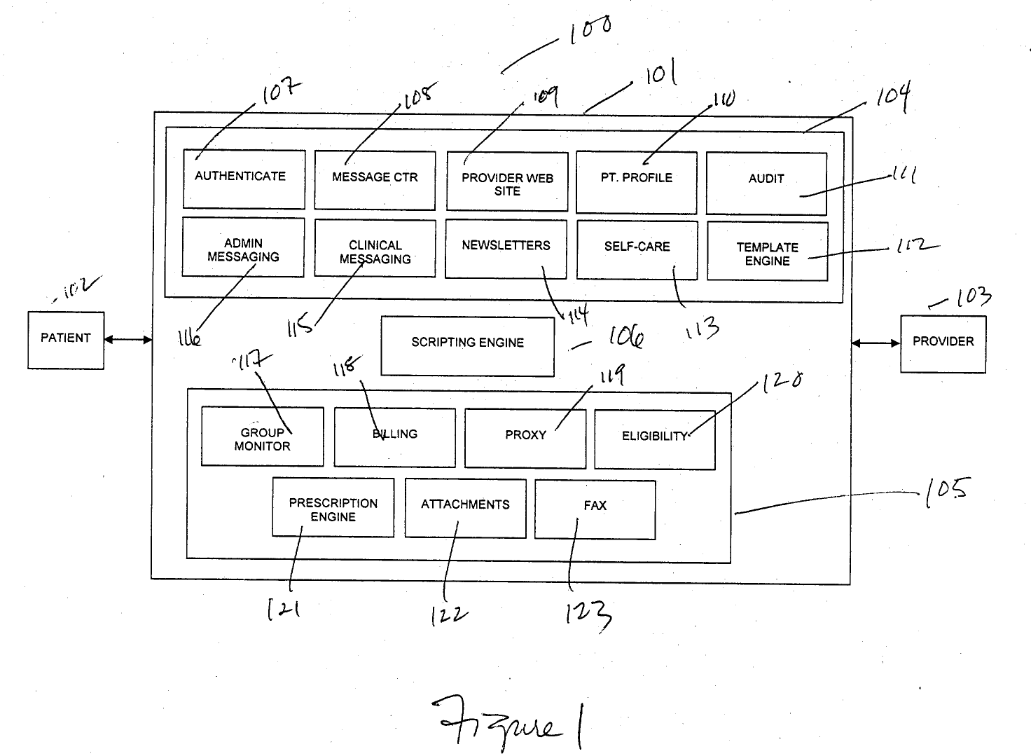

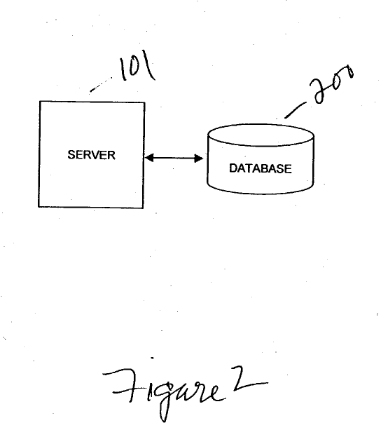

FIG. 1 provides an architecture diagram of a system 100 for managing communication among healthcare providers, patients and third parties. In general, the system includes a server 101 in communication with one or more patient clients 102 and one or more provider clients 103. Additionally, the system may include one or more third-party clients (not shown). Third parties may include allied healthcare providers such as pharmacists; and insurance carriers, commonly known in the healthcare professions as third-party payors. The invented system provides a variety of services to patients, providers and third parties that are designed to facilitate and enable convenient, efficient communication among all parties.

A preferred embodiment of the invention utilizes scripting technology to provide user services. One skilled in the art will recognize that a script is a program having limited capability that sequentially issues commands to a web server to provide interactivity from a web page. The preferred embodiment of the invention utilizes ASP (ACTIVE SERVER PAGES) technology, wherein scripts are embedded in HTML (HYPERTEXT MARKUP LANGUAGE) pages. The commands contained in the scripts are interpreted on the server 101 by a scripting engine 106. Each of the services mentioned above is provided by one or more of the modules 107-112 and 117-123. Additionally, the scripting engine 106 is itself a module. The embedded scripts contain commands that implement the modules providing the services. Additionally, the embedded scripts may also function to format content served up to a client in response to a user request. In the preferred embodiment of the invention, VBSCRIPT is used as the scripting language. However, other scripting languages such as PERL would be equally suitable for practice of the invention. In the current embodiment of the invention, the modules are .COM (COMPONENT OBJECT MODEL) objects—programs encapsulating the requisite business logic for providing the particular service. Additionally other software component technologies would be suitable for practice of the invention, JAVA BEAN's for example.

Referring again to FIG. 1, for the sake of clarity, services have been grouped into separate blocks 104, 105 according to the parties they are primarily intended to serve. In the first block 104 are those services that serve patients and providers alike. For example, an authentication object 107 handles authentication for all users regardless of status. A message center object 108 provides message centers for patients, providers and third parties alike.

On the other hand, in a second block 105 are those services directed primarily to providers and secondarily to third parties, such as the prescription engine 121. While the ultimate purpose of such services may be to serve the patient, the present grouping reflects the fact that the service is accessed primarily by the provider, and possibly the third party, rather than the patient. One skilled in the art will appreciate that the above groupings are merely logical groupings, made for purposes of description only, and do not necessarily correspond to an actual physical arrangement of the server 101. Furthermore, although the server 101 has been shown as a single unit, this too, is merely a logical arrangement. In actual fact, the server side may include more than one server, each configured to provide one or more of the services to be described below.

Many of the service modules function in relative isolation from the remainder of the modules. For example, the self-care module 113 serves up self-care articles to patients. While the self-care module is accessed from the patient's message center, or the provider web site 109, it functions largely independently of other modules. In other cases, a first module provides data to a second module in order for it to provide its service. For example, data from the patient profile 110 is used to inform the scripting engine 106 for a variety of purposes. In still other cases, two or more modules function cooperatively to provide a service. For example, the clinical messaging and administrative messaging modules 116, 115 rely on structured message templates provided by a template engine 112 to provide specialized message types.

Modules residing on the server 101 include:

an authentication module 107;

a message center 108;

a provider web site 109;

a patient profile module 110;

an audit module 104;

an administrative messaging module 116;

a clinical messaging module 115;

a newsletters module 114;

a self-care information module 113;

a template engine 112;

a scripting engine 106;

a group monitor 117;

a billing monitor 118;

a proxy module 119;

an eligibility module 120;

a prescription engine 121;

an attachments server 122; and

a fax module 123.

More will be said below about each of the modules within the context of the respective services each of them provides.

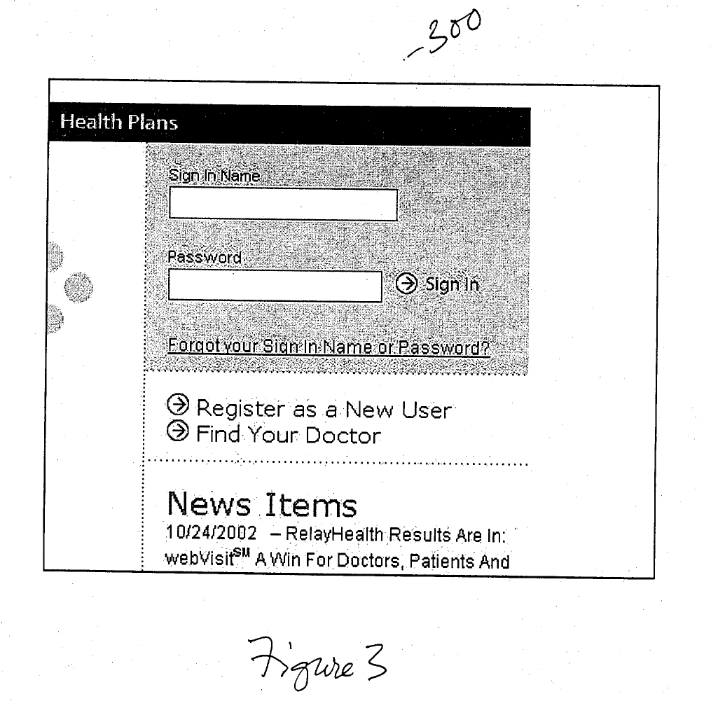

FIG. 2 provides a more detailed view of the server-side architecture. As shown the server 101 communicates with a data store 200, primarily via the scripting engine 106. As needed by the various modules, data is stored and retrieved from the data store 200. For example, the clinical messaging module 115 provides an online consultation in which the patient answers questions provided in a scripted interview. A succinct message to the provider based on the interview results is then composed and forwarded. A number of tools are provided through which the provider responds to the information provided during the interview. The interview scripts themselves are retrieved from the data store, and the patient responses to the questions are stored on the data store 200. The various messaging modules, the patient profile and the prescription engine all generate volumes of data that must be stored and retrieved.

The distributed system is preferably implemented over a publicly accessible data network such as the Internet. Patient and provider clients 102, 103 are preferably conventional web browsers, such as EXPLORER (MICROSOFT CORPORATION, Redmond Wash.) or NAVIGATOR (AMERICA ONLINE, INC., Dulles Va.). Suitable client devices may include many desktop, laptop or handheld computing devices, or alternatively WAP-enabled devices (WIRELESS ACCESS PROTOCOL) such as pagers or cell phones.

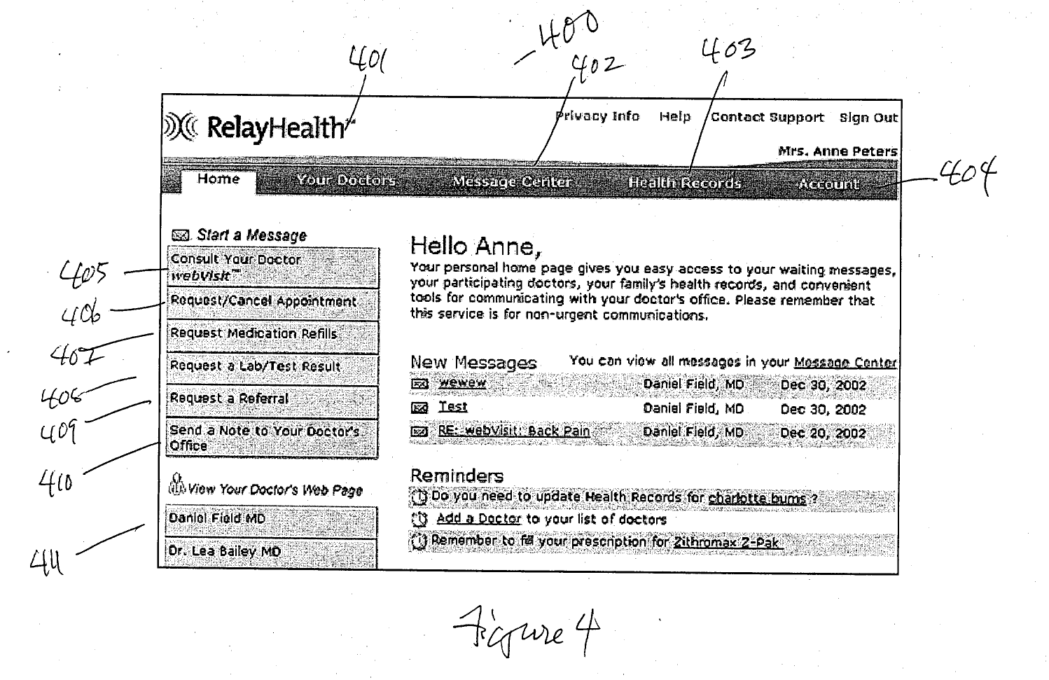

As shown in FIG. 3, users desiring to access the system are authenticated after providing their user name and password from a user interface 300 accessible from the system web page. Alternatively, the system provides a single sign-on mechanism that allows users to access the system from other web sites. For example, the system operator may establish a business relationship with a large group practice or an HMO. The business partner may prefer that their providers and their patients sign-on to the system from their web site, rather than requiring users to navigate to the system web page before signing on. The single sign-on allows the business partner to handle the authentication layer through their web site.

A partner wanting to use the single sign-on feature may first establish a licensing agreement. Once the licensing agreement is established, the partner receives a license key and password necessary to access the system. The single sign-on allows the partners to automate access to all authorized applications through a single login, eliminating the need to remember multiple sign on processes, user ID's and passwords, and providing seamless integration and uninterrupted user experience between internal partner systems and network applications provided by the invention.

The user, either patient or provider (or third party), who is currently logged in and authenticated on the business partner's application requests access to the system by clicking on a link or button in the partner's application;

A request is made from the partner's server to the single sign-on service with the partner's credentials, and the user who is requesting access to the application;

The server validates the partner's credentials and generates a unique URL that the partner may use to perform a single sign-on for the particular user. The URL is only valid for a limited time period, ten minutes, for example, or even less;

The partner's application redirects the user's browser to the URL that was returned from the single sign-on web service;

The browser follows the redirect to the URL; and

The single sign-on server automatically authenticates the provider and generates an active session.

The single sign-on service includes a set of methods for managing users and performing sign-on. Most functions require a partner ID and partner password as the first parameters, acquired from the system operator by obtaining a licensing agreement, as described above. The methods include:

an ‘add user’ method; and

a ‘login’ method.

After being authenticated, the user is navigated to a personal message center.

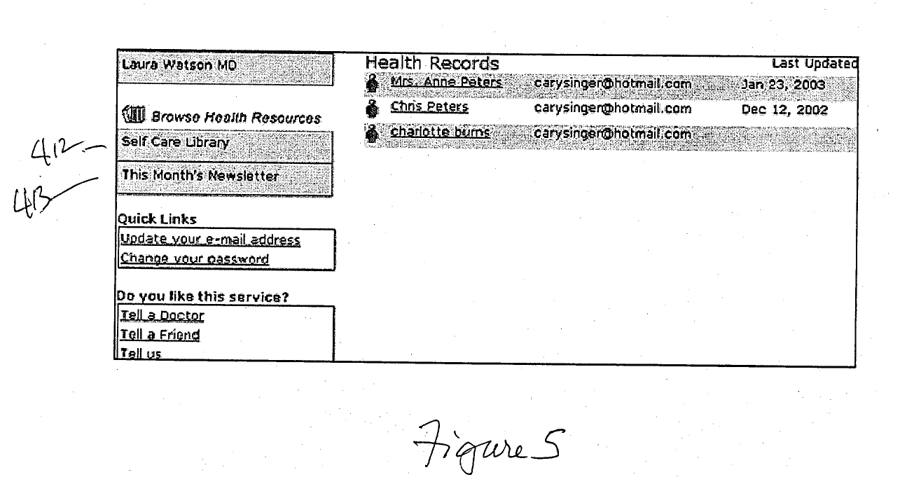

FIGS. 4 and 5 show first and second views of an exemplary patient message center 400.

The patient message center provides a series of links and controls through which the patient gains access to all of the available services provided by the system. Buttons 401-404 across the top of the message center allow the patient to access:

the list of providers they are using the system to communicate with; their inbox;

their health records; and

account information, such as insurance carriers and credit card information.

Buttons 405-413 down the side of the message center page allow the patient to access the various messaging features and services provided on the system:

online consultation (here called a WEBVISIT) 405;

request/cancel appointment 406;

request medication refills 407;

request a lab/test result 408; request a referral 409;

send a note to provider 410;

view provider's web page 411;

self-care library 412; and

current newsletter 413.

It will be apparent to the skilled practitioner that the choice and placement of controls is a matter of design choice—other types of controls and placements are entirely within the scope of the invention.

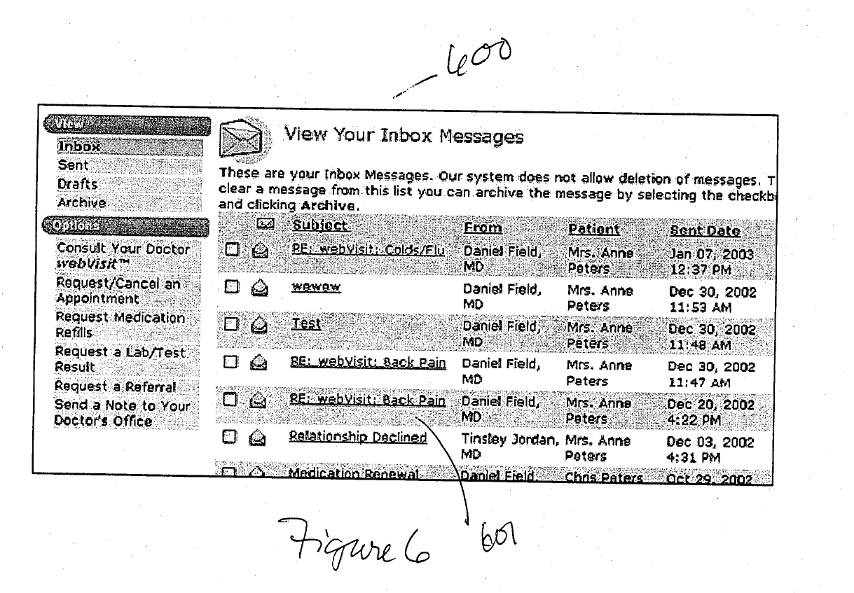

FIG. 6 shows a patient view 600 of the message center 108. The message center provides a complete message history. Interaction with the various interface elements strongly resembles use of common e-mail applications. Hyperlinks 601 are provided, selection of which allows the user to view the corresponding message. The list view provides subject, sender, patient, and date sent for each message.

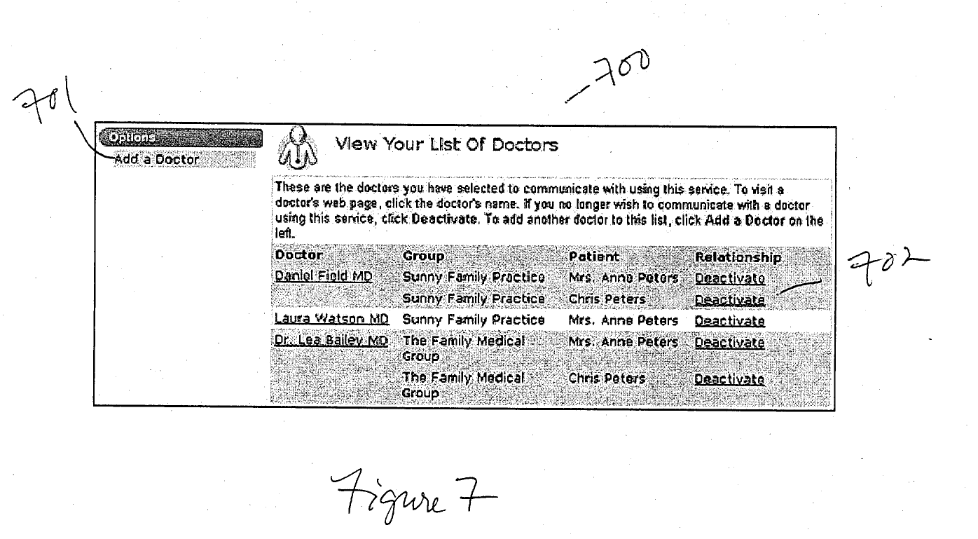

FIG. 7 provides a view 700 of the list of providers the patient is using the system to communicate with. From this screen the patient is also able to add providers 701 and delete 702 them.

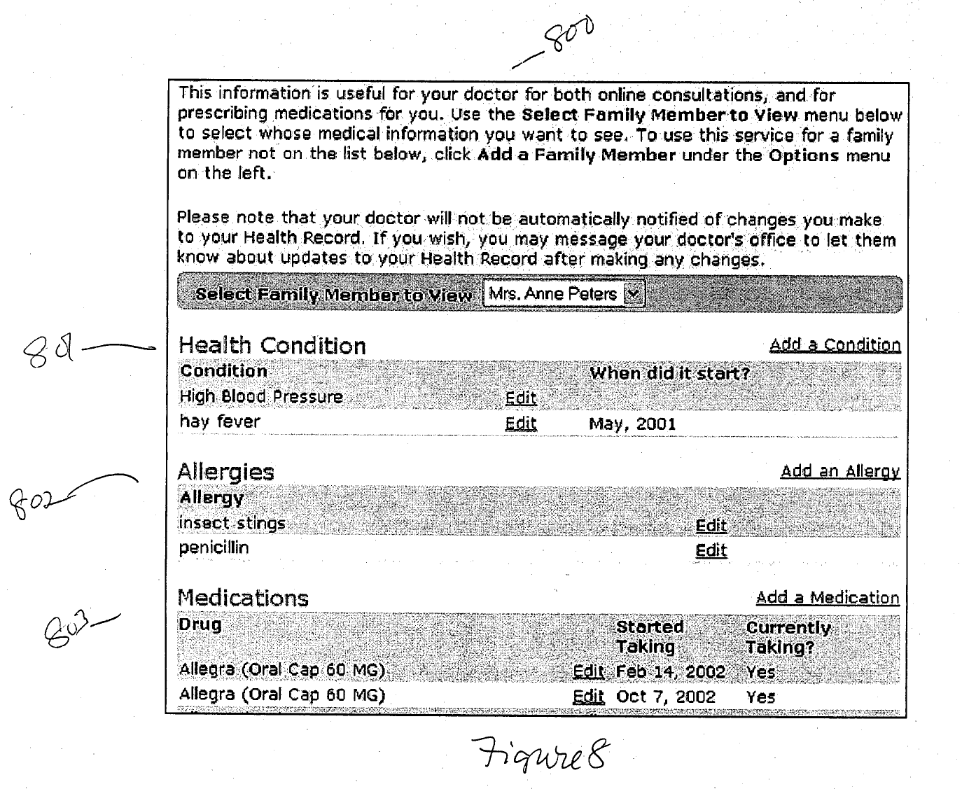

FIG. 8 provides a patient view 800 of the patient profile 110. The patient profile provides a record of important health-related information for each patient. The patient profile has several purposes within the system. Among these are:

it provides data set criteria for the clinical logic that drives such things as pushed preventive care, content email items, future health tutorials and self-monitoring tools;

it provides data set criteria to determine health/disease risk stratification for physician interventions and health disease outcome monitoring;

it provides the necessary terms to assign subsystem vocabularies like such as NDC (National Drug Codes) codes for patient medications, ICD9 (International Classification of Diseases) codes for diseases, and CPT (Current Procedural Terminology) codes for appointment procedures;

it provides the necessary history justification for each online consultation required for reimbursement. ICD9, 10 and CPT 4 codes are required fields of all office visit claims forms, including the HFCA (Healthcare Financing Administration) forms; and

it acts as a gathering tool and pulls user data to the database to assure a data set in medical and informational decision making within the WEB VISIT (online consultation).

Using the profile, the patient is able to list health conditions 801, and medications 803. The health profile allows the patient to specify particular health problems, when the condition started, and the provider currently providing treatment or care for the condition. Additionally, the patient can specify allergies 802, both to drugs and environmental allergens. The patient is also able to add medications to the history and specify when they started the medication and whether they are currently taking the medication. As will be seen further below, providers and their staff can also view the patient profile and make changes to it.

Messaging

It will be appreciated that one of the fundamental functions of the system is that of a messaging platform. Messaging functions are mediated through clinical 115 and administrative 116 messaging modules. Clinical messaging includes online consultation, requests for test/lab/results and prescription refills. Most other message types are handled by administrative messaging. The system also provides the provider the capability of assessing fees for certain services provided, as described in greater detail below. In the preferred embodiment of the invention, fees may be assessed for clinical messages such as online consultation, while no fee is typically associated with administrative messages.

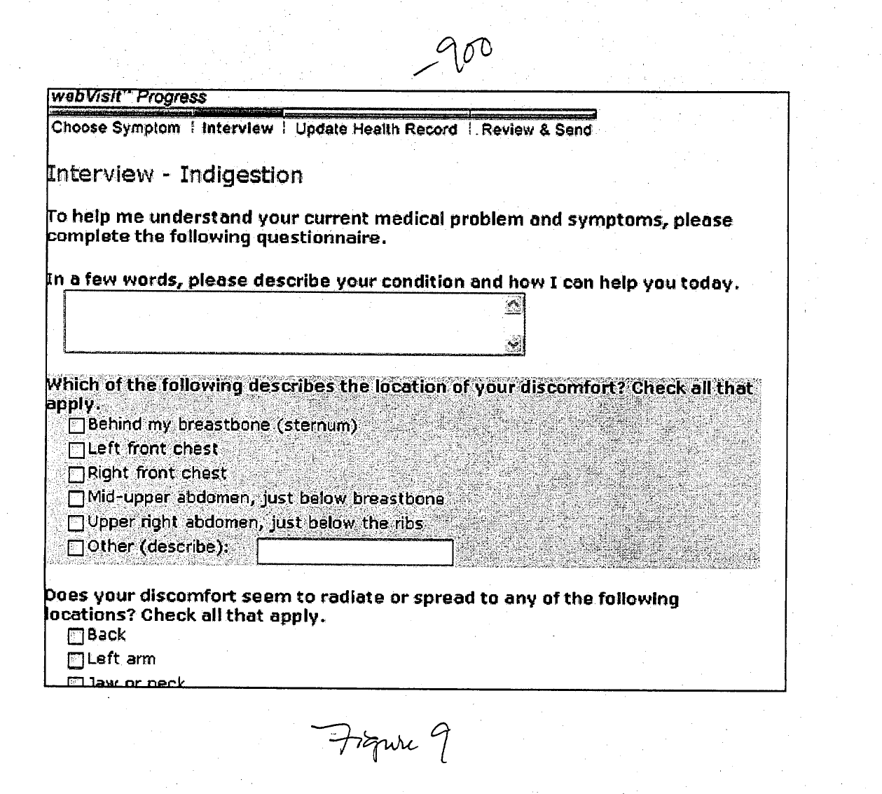

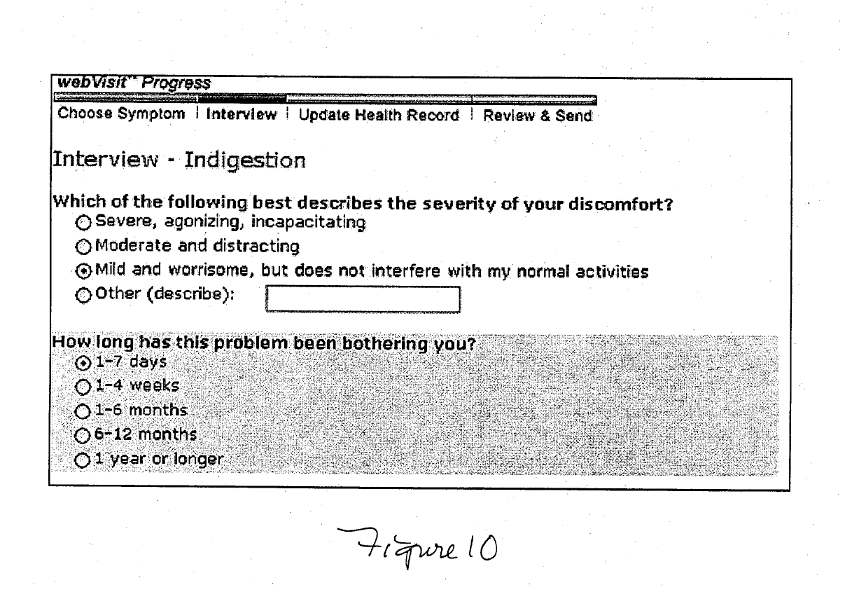

FIGS. 9 and 10 provide a patient view 900 of a scripted interview for an online consultation. As described previously, the online consultation is one of the messaging functions provided by the clinical messaging module 115. The system provides scripted interviews for a large variety of non-critical health conditions. For example, FIGS. 9 and 10 show a scripted interview for indigestion. The patient completes the interview, and a message to the provider is composed on the basis of the patient's responses. As will be seen later, the provider may respond with a prescription, a request that the patient come in to be seen, or a link to appropriate self-care information. In addition to providing consultation for minor, non-critical conditions that may not require an office visit, the online consultation also provides pre-visit interviews for the patient to complete prior to seeing the provider in their office. The online consultation is also used to provide care and consultation for chronic conditions, for example to review patient compliance with a care plan for a chronic condition such as diabetes.

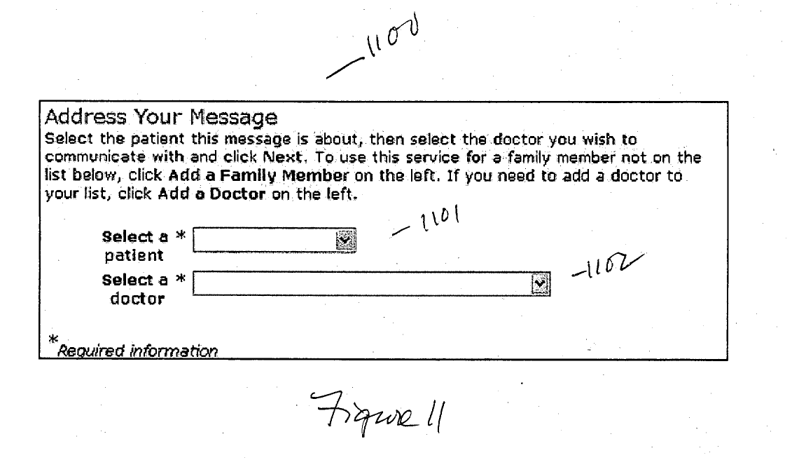

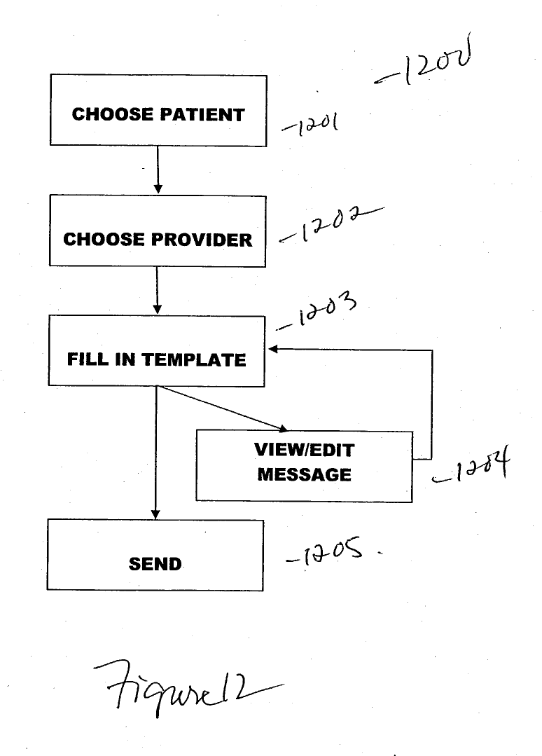

In addition to the online consultation just described, the system provides a number of other message types 406-410 as shown in FIG. 4. As previously described, the system provides a number of special message types: requests for appointments, prescription refill requests, requests for lab results and administrative inquiries such as billing requests. Such specialized message types depend on the use of structured message templates, wherein portions of the required information are filled out for the sender. Upon selecting any of the message types 406-410, the user is navigated to a screen 1100 as shown in FIG. 11, providing dropdown menus 1101, 1102 for selecting patient and provider. FIG. 12 shows the flow of a generalized procedure 1200 for the use of the structured message templates:

choose the patient 1201; choose the provider 1202;

fill in the template 1203;

view and edit the message if necessary 1204; and

send 1205, after the message content is satisfactory to the sender.

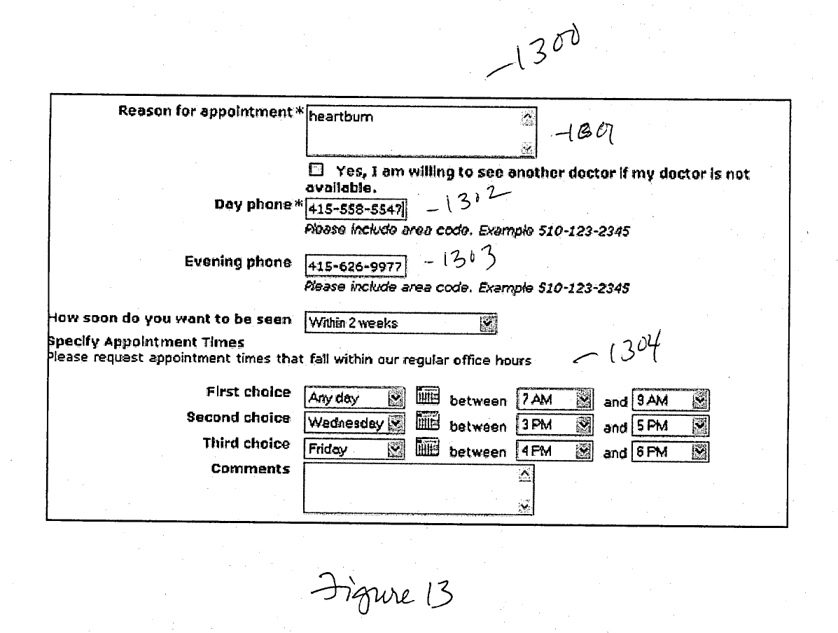

As shown in FIG. 13, the system provides a structured appointment request 1300 that aids the patient in requesting an appointment from multiple dates and times. Additionally, the structured appointment request allows providers and their staff to easily apprehend the request and use the information for their appointment scheduling. Furthermore, providers also have the capability of initiating an appointment message, described further below.

The process flow for an appointment request is as follows:

Patient requests appointment:

patient clicks on a ‘request/cancel appointment’ button 406 from their message center;

a screen pops up the provides the choice of scheduling, canceling or rescheduling an appointment (no shown);

after selecting ‘request new appointment’ a structured message template 1300 pops up that requests additional information:

reason for appointment 1301;

day phone 1302;

evening phone 1303;

requested dates and times 1304.

As in FIG. 12, the user completes the template, views and/or edits it, and sends it.

Provider/staff receives appointment request—the patient's appointment request is displayed by means of a message template almost identical to that of FIG. 13;

Provider/staff clicks on ‘reply’ button (not shown);

A structured message screen pops up that permits the provider/staff to select an acceptable date and time from among the dates and times requested; or provide alternates if none of the choices specified by the patient is acceptable.

Patient receives reply:

Patient receives a structured reply to their request;

Reply contains an available date and time from the patient choices or provides one more alternate choices;

Patient confirms the provided dates, or requests another appointment; and

Confirmation is sent.

As above, a provider may also initiate an appointment message (not shown):

provider/staff clicks a button to attach an appointment in a structured ‘message to patient’ screen;

provider/staff specifies available appointments in ‘appointments’ screen; and

the appointments are populated in the message; and

The message is sent to the patient.

It will be noted that messaging related to appointments is preferably handled by the administrative messaging module 116.

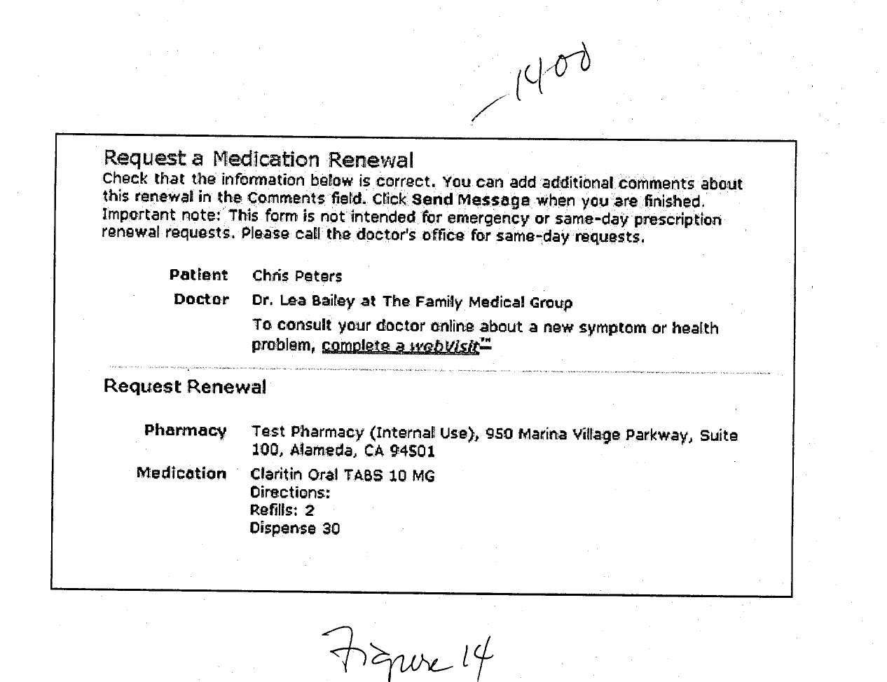

FIG. 14 shows a completed request 1400 for renewal of a prescription. With minor variations, the process flow for prescription refills and renewals mirrors that of FIG. 12: the user selects a patient and provider; a particular prescription is selected from a list; a structured template requests additional information such as the prescription number; the user reviews and/or edits the message and the completed message is sent. It will be noted that messages relating to prescription medications are preferably handled by the clinical messaging module 115.

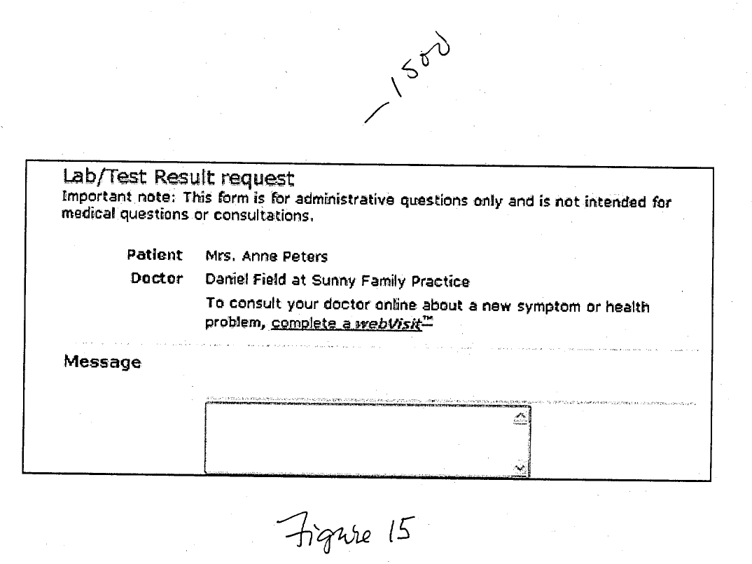

FIG. 15 shows a structured template 1500 for a lab/test result request. Process flow is substantially that of FIG. 12. Requests for lab and test results are preferably handled by clinical messaging.

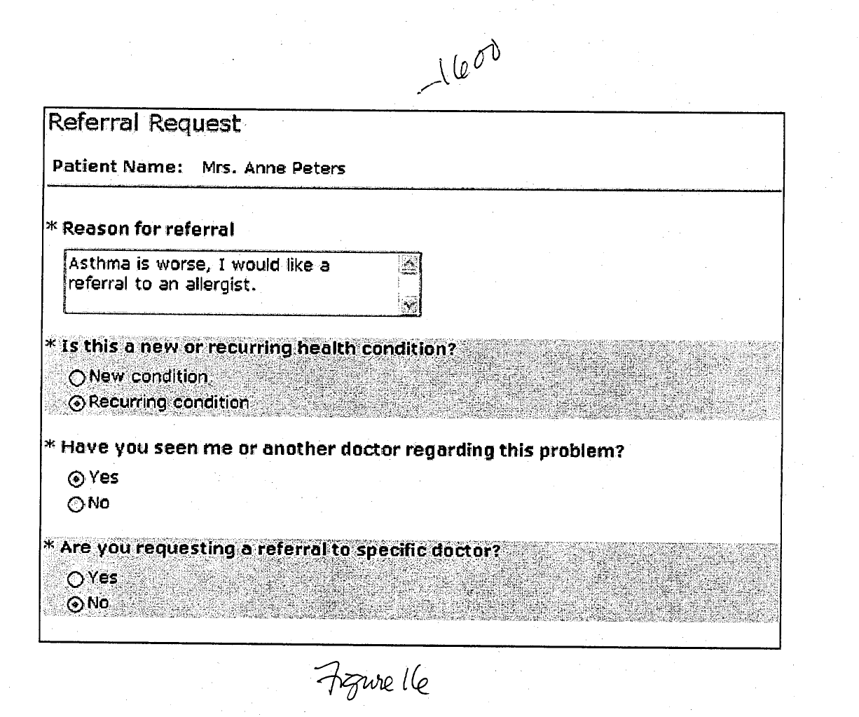

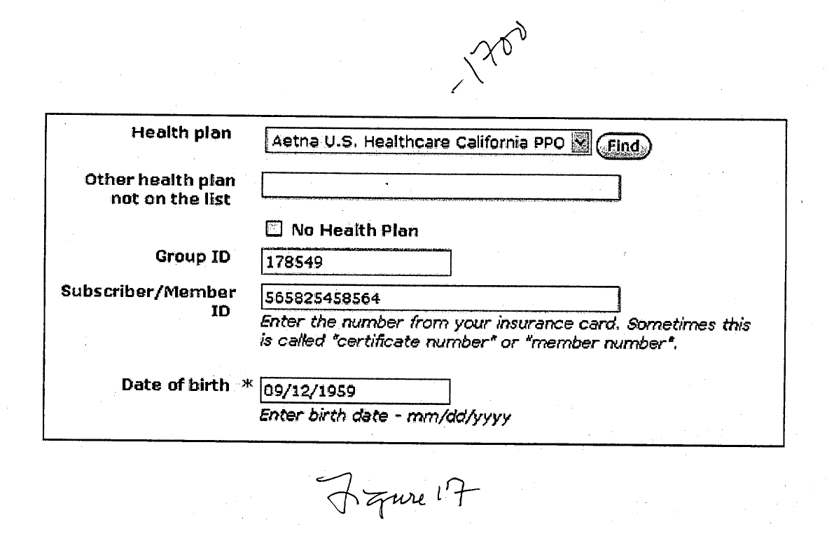

FIGS. 16 and 17 show first 1600 and second 1700 screens from a structured template for a referral request. The user first supplies the information requested by the first screen 1600, whereupon they are navigated to the second screen 1700 to update their account information.

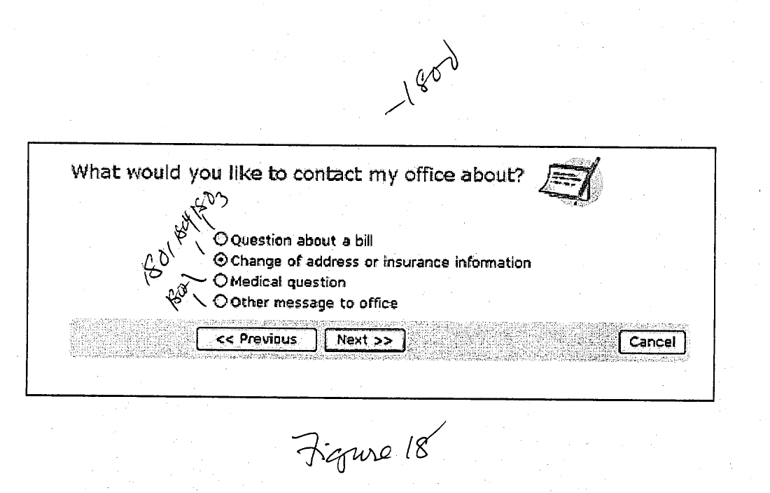

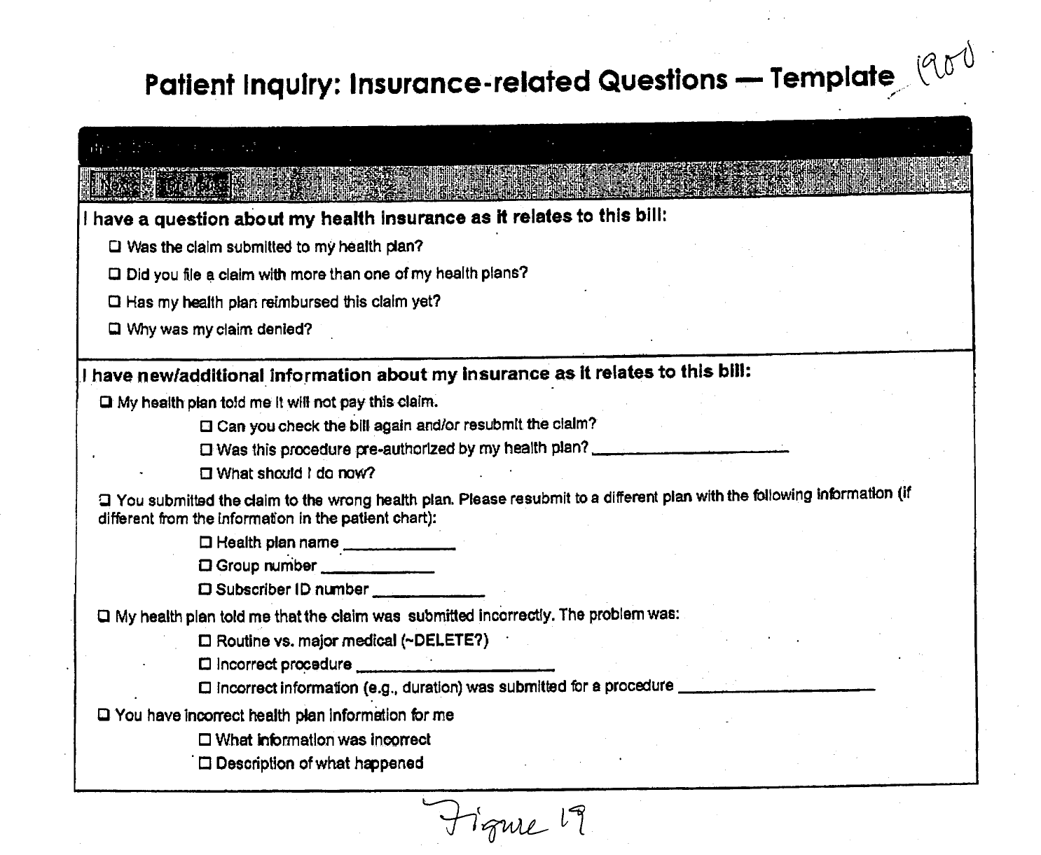

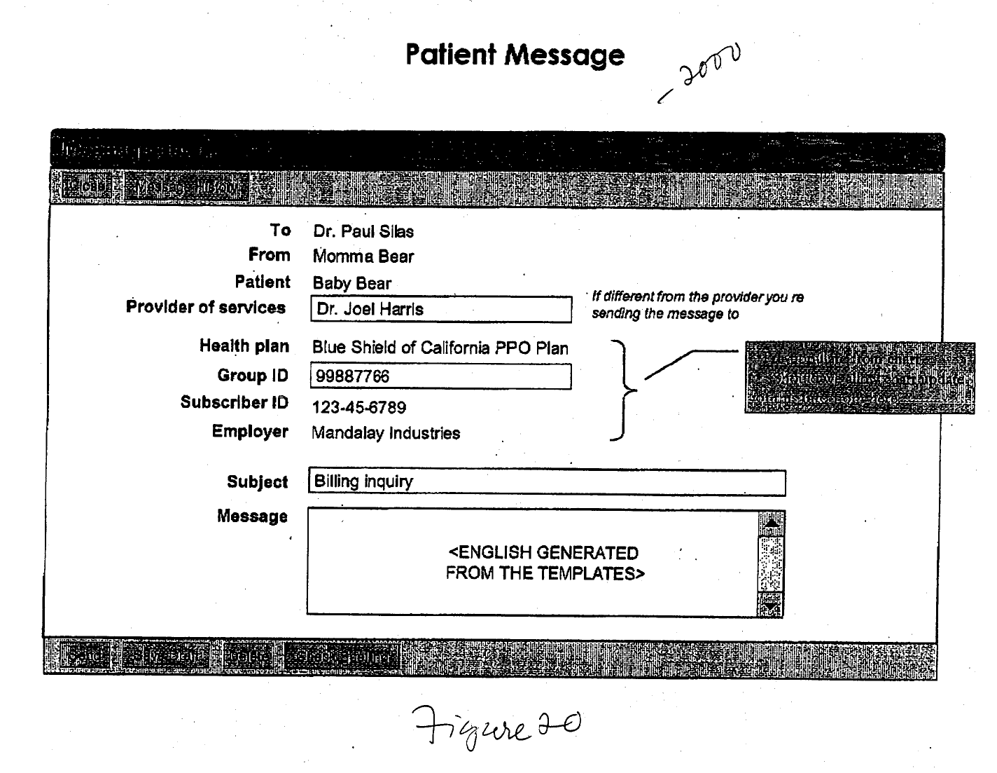

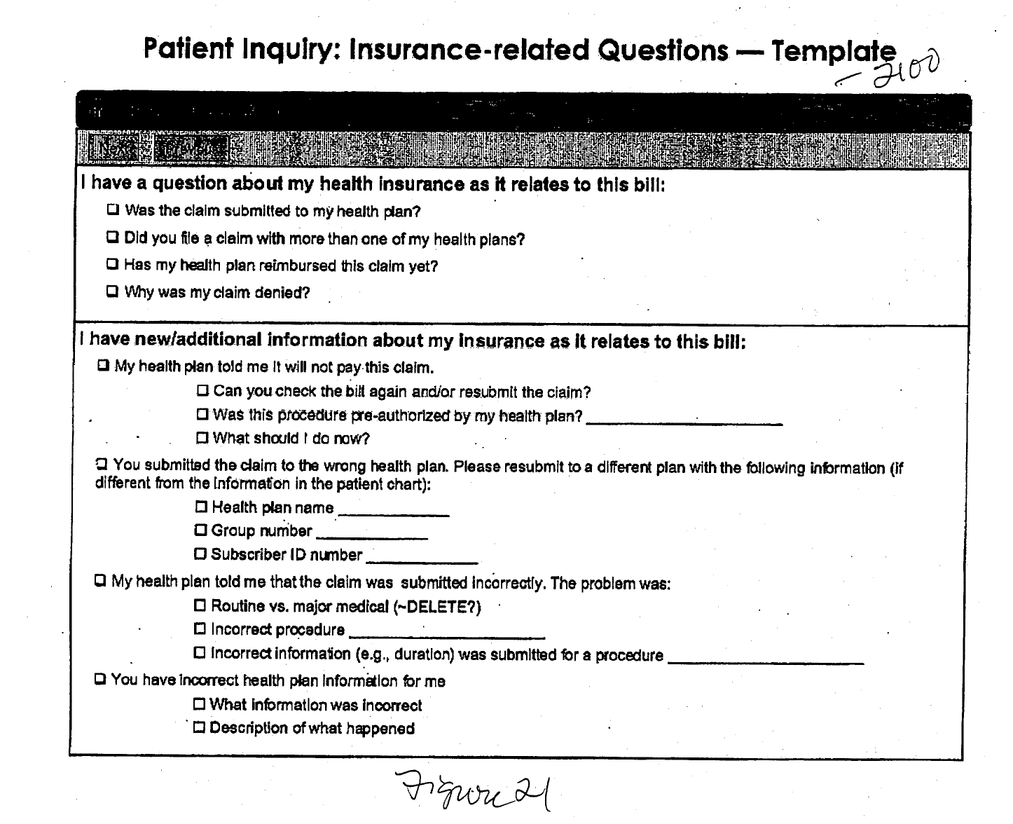

Upon selecting the ‘send a note to your doctor's office’ button 411 from their message center page, the user is navigated to a menu 1800 of message options as shown in FIG. 18. Should the user select ‘Medical’ question 1801, they are redirected to a screen for initiating an online consultation. Selection of an ‘other’ message 1802 navigates the patient to a general message template. Selections 1804 or 1803 navigate the user to structured message templates 1900 or 2100 as shown in FIGS. 19 and 21.

FIG. 19 shows a structured template for billing inquiries. Upon furnishing the information requested by the template, a billing inquiry message 2000 is generated, reviewed by patient and sent. FIG. 21 shows a structured template for insurance-related inquiries. Upon furnishing the information requested by the template, a billing inquiry message (not shown) is generated, reviewed by patient and sent.

Provider

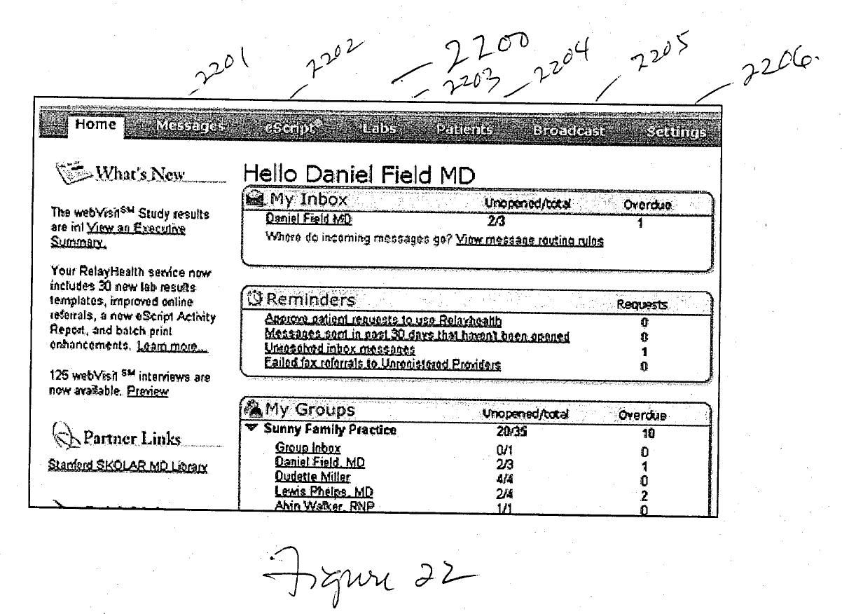

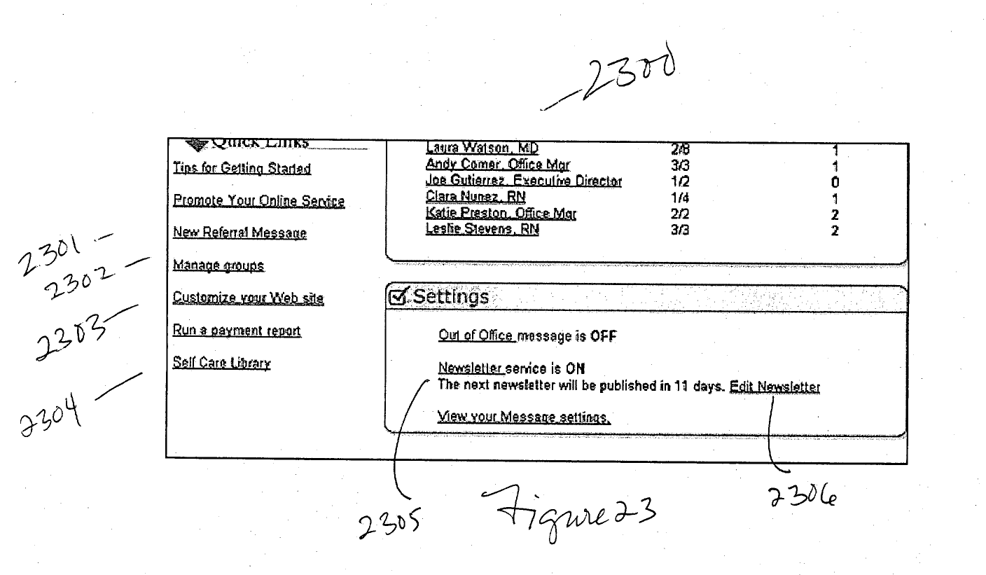

The above description of the invention has been primarily directed to those aspects and features of the system that are accessible to patients. However, as with patients, after a provider has been authenticated on the system, they are navigated to a personal message center 2200, as shown in FIGS. 22 and 23. A series of links grants access to:

a provider inbox 2201;

a screen for generating online prescriptions;

a series of structured message templates for reporting lab/test results to patients 2203;

a searchable list of patients 2204

broadcast settings for patient education products such as a newsletter and care plans 2205; and

account settings such as fees and group settings 2206.

FIG. 23 shows a second view 2300 of the provider message center. Links are provided for:

initiating a new referral message 2301;

managing groups 2302;

customizing the provider web site furnished by the system 2303; accessing a library of self care articles 2304;

enabling publishing of a provider newsletter 2305; and

editing the newsletter.

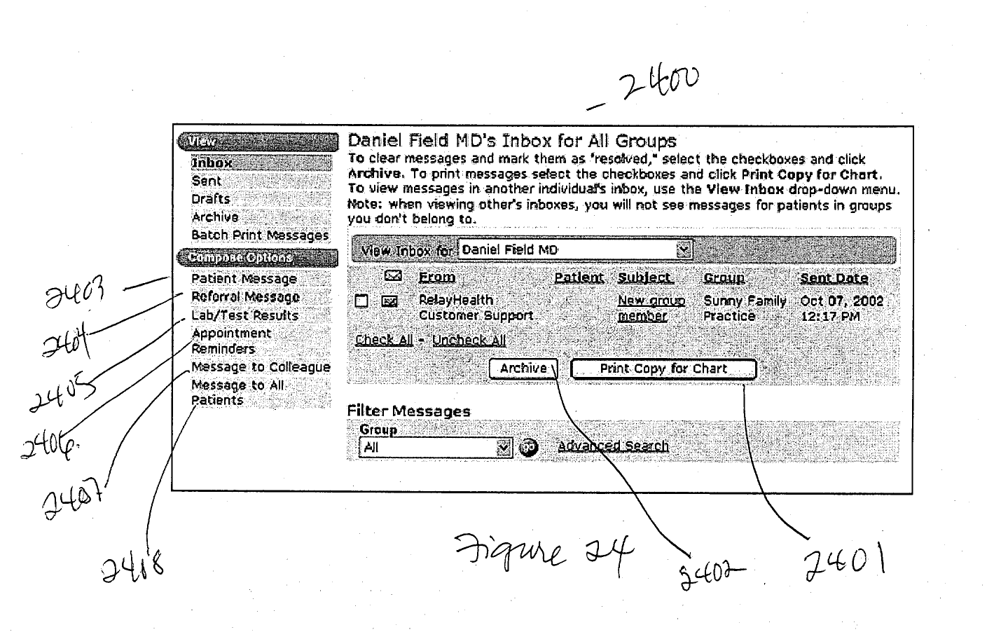

FIG. 24 shows a view of the provider message center 2400. As in the patient message center, the provider message history is displayed. Controls 2401 and 2402 are provided for printing and archiving of messages. A series of ‘compose’ options is provided:

patient message 2403;

referral message 2404;

appointment reminder 2405;

messages to colleagues 2406; and

group messages to all patients 2408.

As will be seen, the special message types available to the provider rely on structured message templates very similar in function and appearance to those available to the patient.

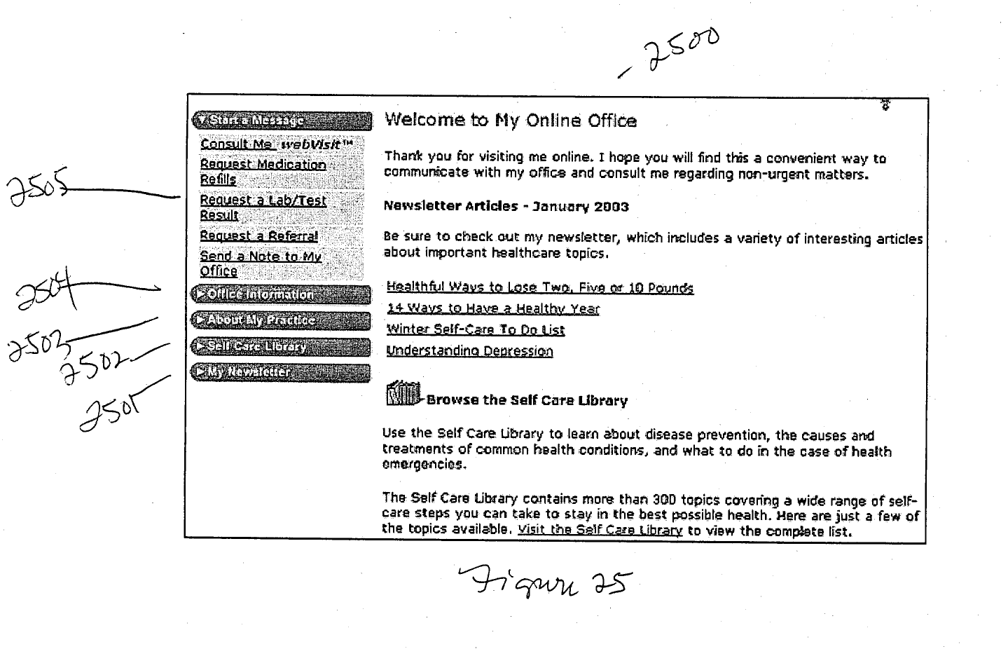

As shown in FIG. 25, the system includes a customizable web page 2500 for each provider. If the provider has so configured the web page settings, the provider's newsletter 2501 is published to the page. Links are also provided to the self-care library 2502— described below; practice information 2503, such as a mission statement and the provider's qualifications and certifications; and office information 2504, such as office hours and address.

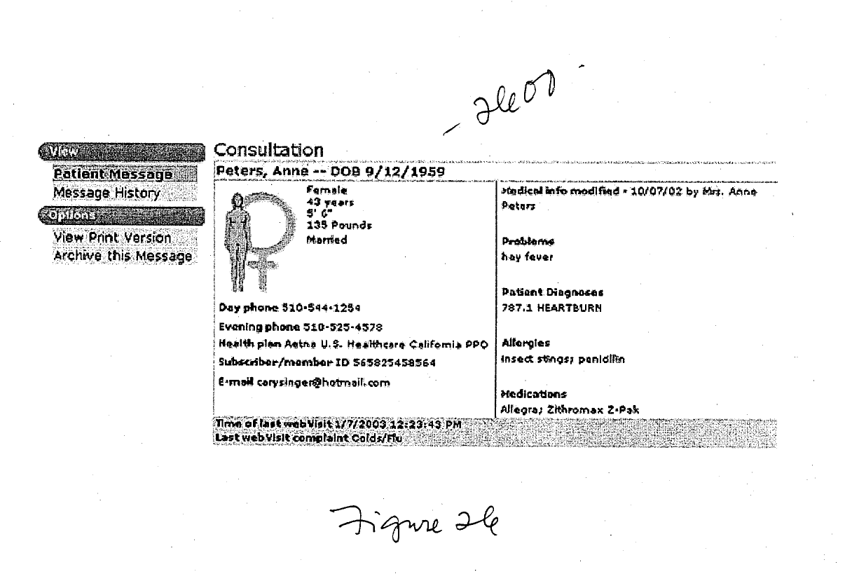

FIG. 26 shows a provider view of an online consultation message received from a patient. Upon opening the message, the provider is first presented with the patient's face page 2600. The face page gives the provider essential biographical and clinical information about the patient at a glance, for example:

sex

age;

height and weight;

contact information;

insurance information;

problems;

diagnoses;

allergies; and

current medications.

Paging down from the face page, the provider is presented with the record of the scripted interview completed by the patient (not shown). Following the interview record, controls are provided for replying to, printing, routing or saving the message (not shown).

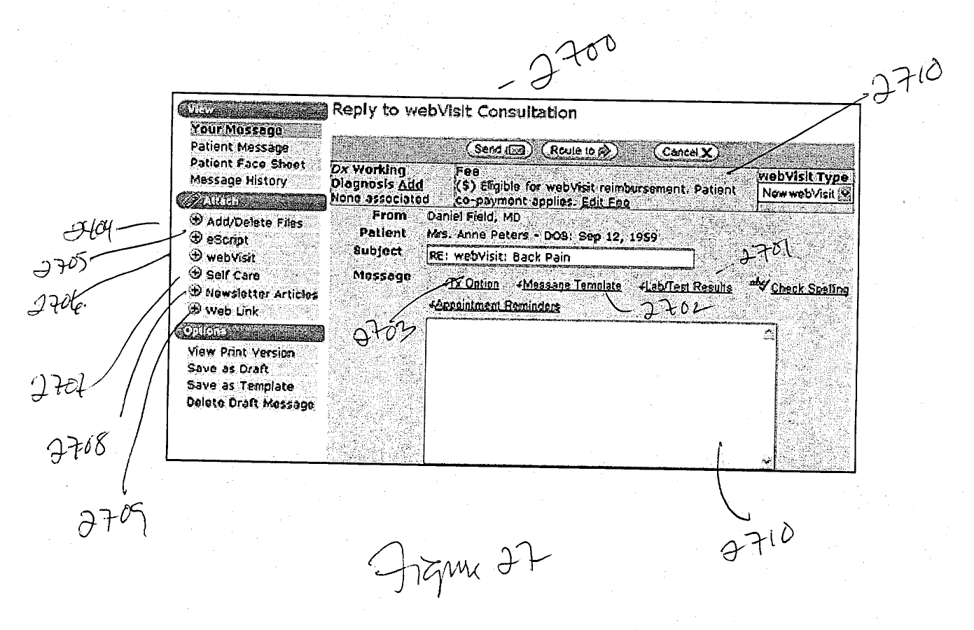

FIG. 27 shows a structured template 2700 for reply to an online consultation. A control 2710 is provided for assessing a fee: responding to an online consultation is generally one of the services that the provider bills for. More is said below about fees and charging.

A number of special message options are provided for responding to the online consultation. A link to ‘treatment options’ 2703 navigates the provider to a template that lists treatment options for the patient's particular problem. The provider selects the treatment options for the patient in question. Some of the treatment options require customization to the patient. For example, if the provider wishes to see the patient in the office, the time frame and the level of urgency can be specified.

The provider can select from a number of message templates 2702 that they have customized according to their own practice needs.

The provider may select from a number message templates 2701 for reporting lab/test results.

A number of additional options are provided that can be attached to the main body of the message:

additional files 2704;

a prescription 2705;

an online consultation interview 2706 for the patient to complete;

selections from the self-care library 2707;

newsletter articles 2708; and

links to other information sources 2709.

When the provider utilizes a message template, after the template is completed, the text is automatically pasted into the message body 2710. Additionally, the provider may simply compose a message of their own in the message body. It is important to point out that the provider is not limited to any single option, or combination of options. Any or all of the options may be utilized in composing a reply to the patient's online consultation.

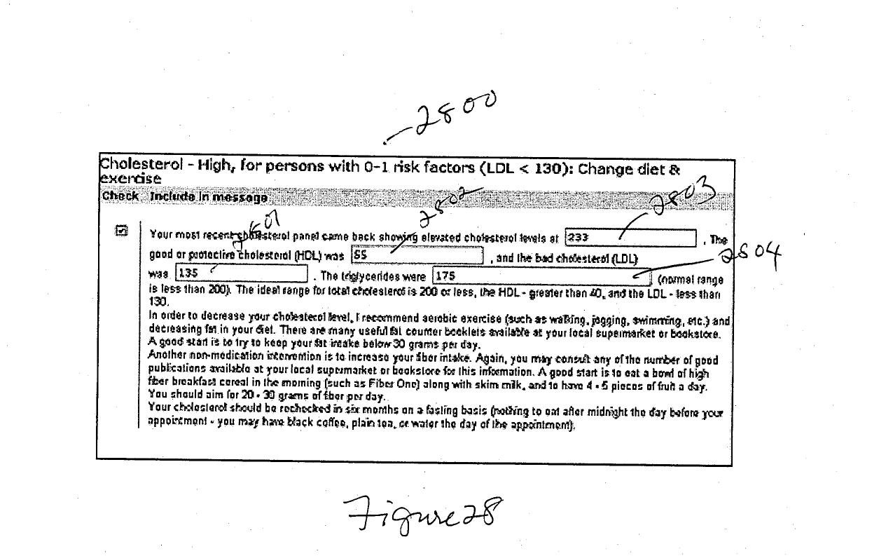

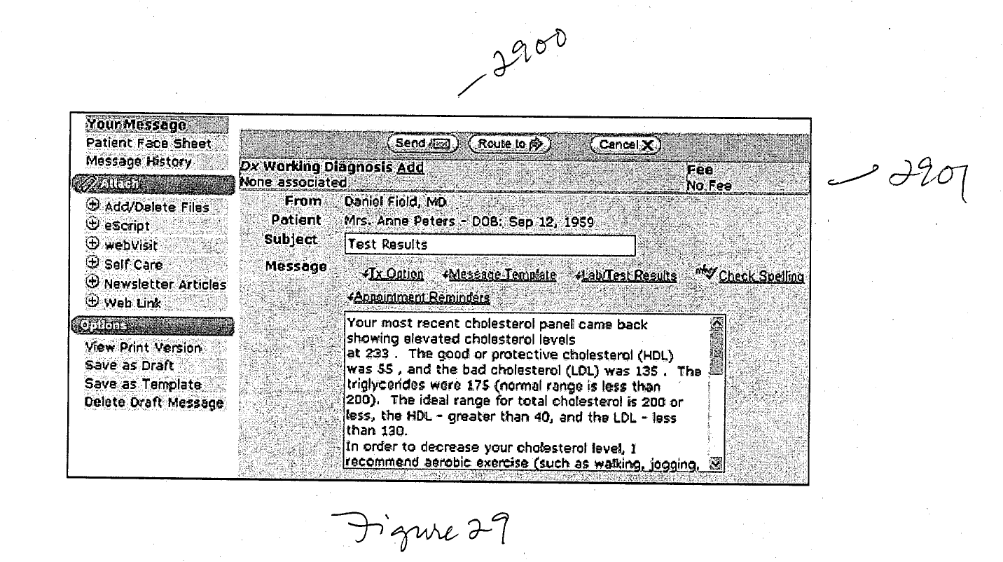

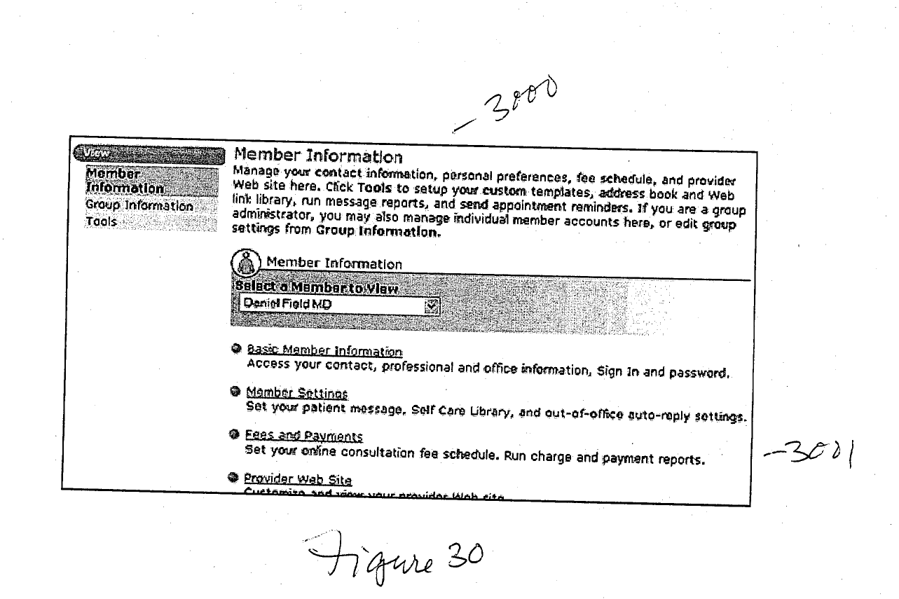

FIG. 28 shows an exemplary template 2800 for reporting the results of a blood lipid panel. Blank fields 2801-2804 are furnished for the provider to enter the values. After the template is completed, the text is automatically pasted into a message body, as shown in FIG. 29.

The system also provides the provider/staff with the capability of attaching an appointment request to a clinical communication. When the provider chooses to add an appointment request from the ‘compose message’ screen, he or she is navigated to a screen that allows selection of a time frame within which they would like to see the patient. When the user clicks ‘save’ they are returned to the ‘compose’ message screen, now with an attachment containing a link that navigates the patient to a screen that allows them to compose an appointment request. The message body may contain a text message such as:

“I would like to see you in my office <TEMPLATE SELECTION>. Please click the link in the attachment below to request an appointment at a time that is convenient for you. <ADDITIONAL COMMENTS>”

Charging

As shown in FIG. 29, message templates for fee-based services include a fee field 2901 that displays the fee to be charged the patient for the service. Providers may elect to charge the patient an out-of-pocket fee, where appropriate, for services not covered by the patient's third party payor. As shown in FIG. 29, no fee is to be charged for the service. This may be because the provider elects not to charge the fee, or because the service is covered by the patient's payor. The provider has the option of applying charges at the time he or she sends the patient a message, as in FIG. 29. Additionally, the provider has the option of overriding fees, if he or she chooses. The charges are set according to a fee schedule and charging rules established by the system operator. Additionally, at the time of requesting the service, the patient is advised that the service may be fee-based, and a link is provided that navigates the patient to a listing of the provider's fees for specific services. The charging rules established by the system operator may also establish fees to be paid to the system operator for use of the system. Preferably, the fees are established according to the fee paid to the provider, either by the patient, the third party or both. Fees to the system operator may be paid by the patient, a third party, or by the provider.

Charges are actually applied at the time the patient opens the message from the provider. As previously described, the patient message center 400, shown in FIG. 4, gives the patient the option of configuring their account parameters 404. In the current embodiment of the invention, co-payments and out-of-pocket fees are charged to the credit card specified in the patient's account settings, at the time the patient accepts the fee-based message, although other payment methods are possible, such as charging against a deposit account. The patient may be provided the option of declining a fee-based message, in which case the fee would not be assessed and they would not be permitted access to the physician-generated response.

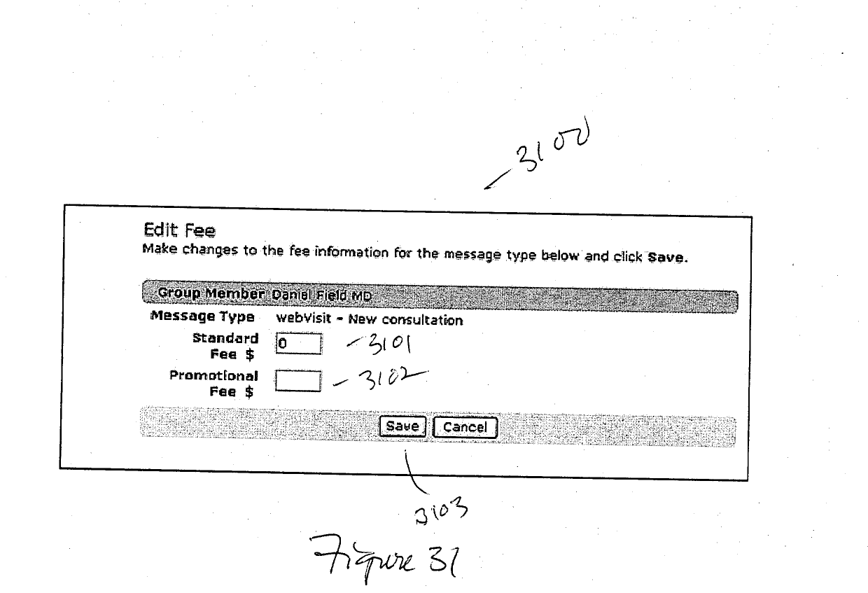

As shown in FIG. 22, a link 2206 from the provider message center navigates the provider to a menu of configurable account settings 3000; one of the options being fees and payments 3001. Selecting the fees and payments link 3001 navigates the provider to a listing of all fee based services (not shown). Selecting a link for one of the services navigates the provider to an edit screen 3100 as shown in FIG. 31. Fields are provided for setting a standard fee 3103 and a promotional fee 3102. After entering the desired fees, the provider may save changes by activating a ‘save’ button 3103. As indicated above, permissible ranges for fees are established by the system operator.

Groups and Members

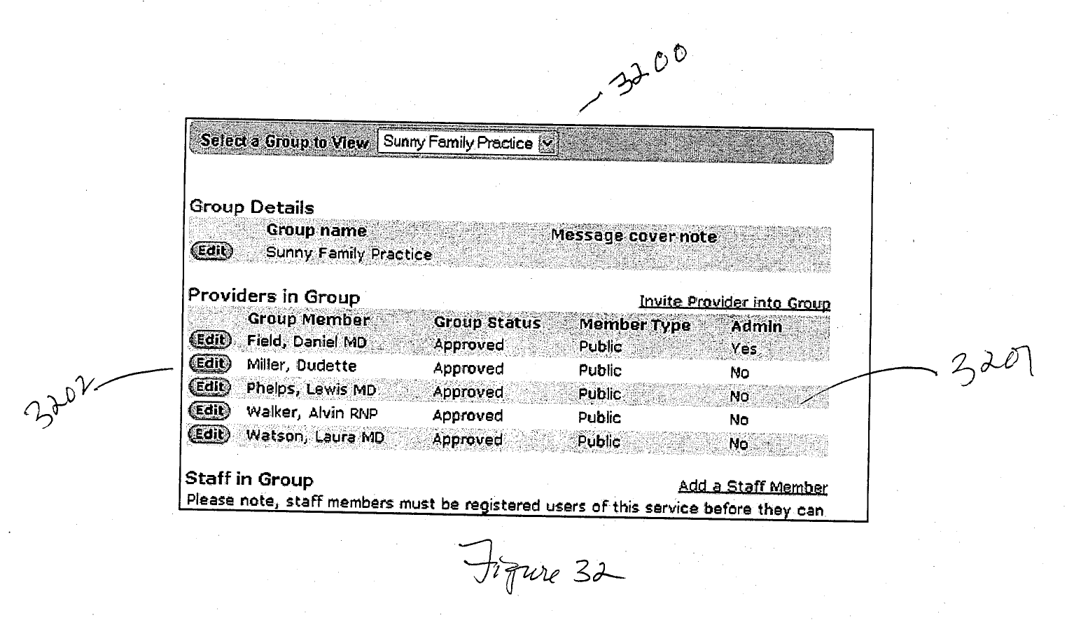

FIG. 32 shows a user interface 3200 for setting rights and privileges for individual members. The user interface provides a listing 3201 of all group members, grouped according to type, either provider or staff. An edit button adjacent each group member's name grants a group administrator access to the member's record.

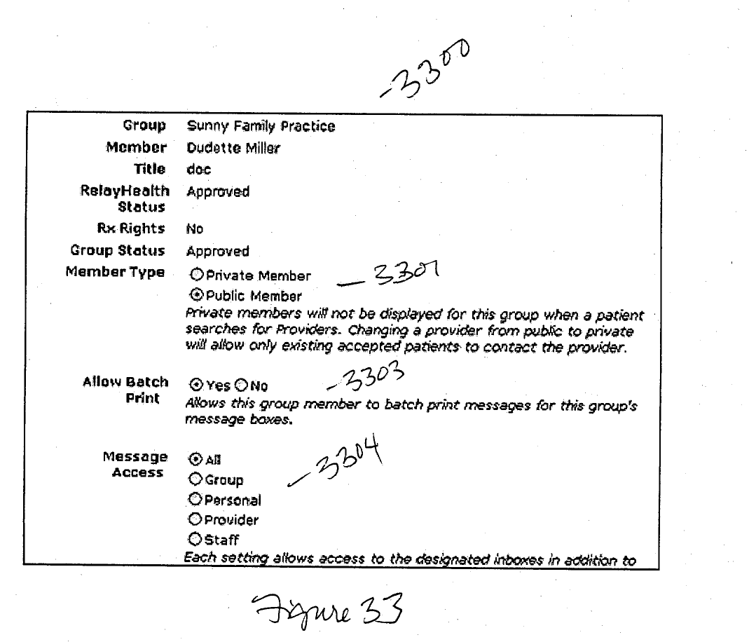

FIG. 33 shows a provider record 3300. As shown, providers may be either private or public members, wherein a private member is group member, but is not publicly listed as such. Providers may be authorized to batch print messages 3303 for the group, and they may be granted access to designated message centers 3304 in addition to their own. Additionally, providers may be given group administration rights. It will also be noted that certain permissions for providers are set at the system level, and are not accessible to the group administrator. For example, the right to prescribe is granted at the system level only after the provider has furnished his or her credentials to the system operator.

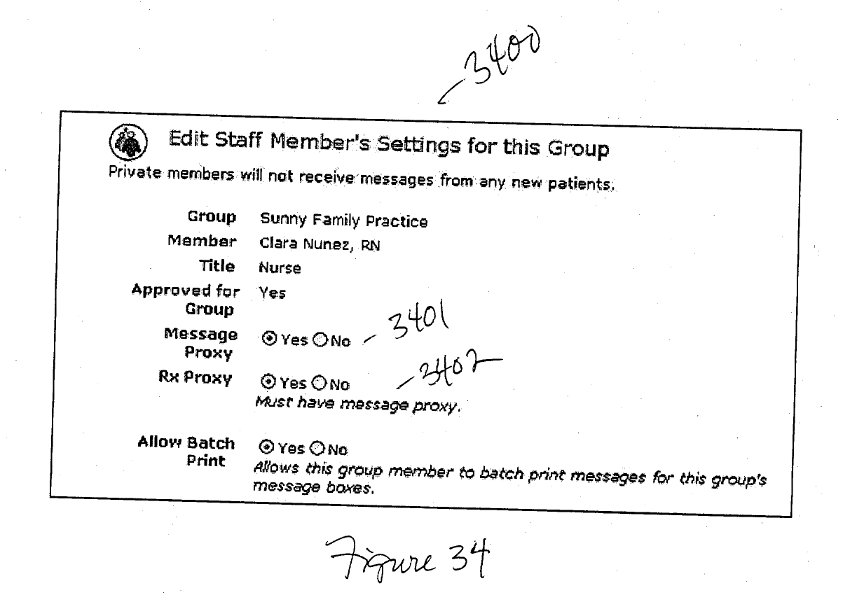

FIG. 34 shows a staff record 3400. Possible rights and privileges for staff members are identical to those of providers, except that staff members can be given the status of message proxy 3401 or prescription proxy 3402. Message proxy allows the staff member to answer messages on behalf of providers. Prescription proxy allows the staff member to order prescription renewals and refills on behalf of providers. Discretion as to who among the staff members are qualified to assume the role of message or prescription proxy is left to the group administrator.

The group monitor 117 provides a user interface (not shown) for viewing the status of all messages for members of a group, advantageously providing a means for group members having message proxy and prescription proxy rights to identify pending messages readily and take action on them within the prescribed response time.

Group administrators have the ability to enable group services: patient messaging, prescribing service, and prescription attachments; and to turn on and off specific message types: appointment requests, online consultations, lab/test results and the like. Furthermore, group administrators have the ability to “lock down” services and message settings for the entire group. Such action overrides individual providers' current settings. Group administrators also have the ability to edit contact information, provider web site information, group web site information, newsletter settings, and fees and payments for each provider. A party who created a group is automatically given group administration rights. Settings for group administration rights can be adjusted in the provider and staff details screens by clicking ‘Edit’ for a group member on the settings—group information—groups and members page.

Message Options and Routing

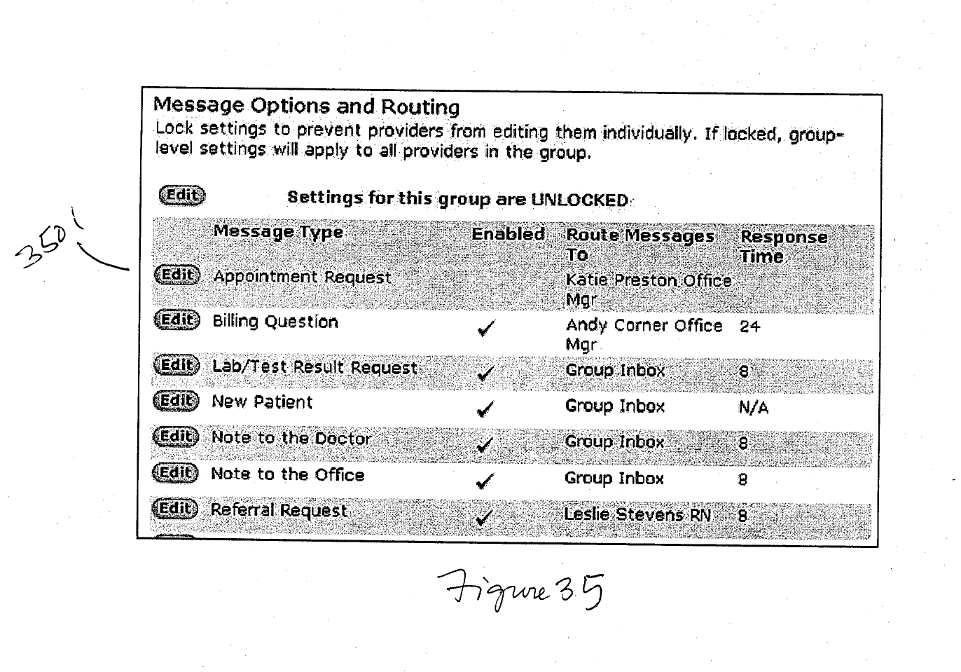

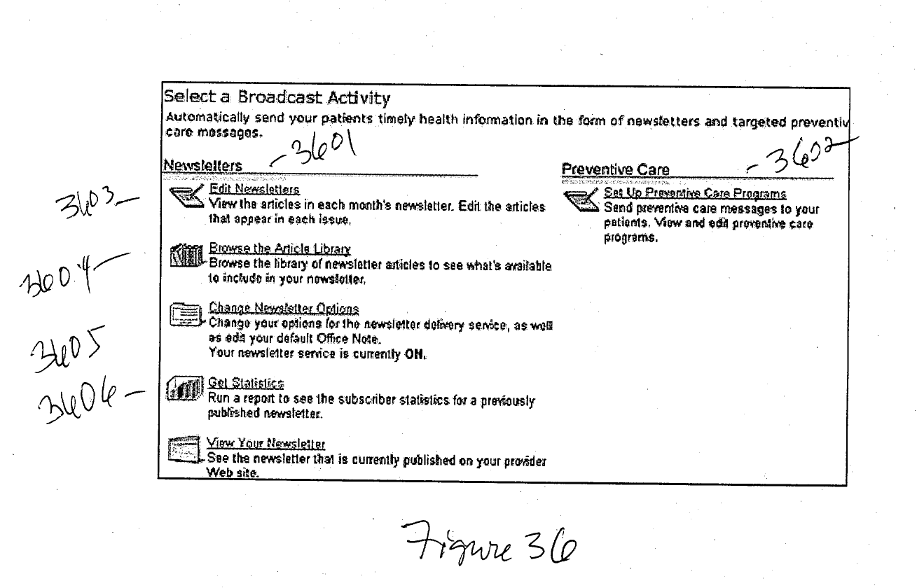

As FIG. 35 shows, the group administrator may set message options and routing for particular message types. As above, the group settings may be locked to prevent individual providers from changing them. A button 3201 adjacent each message type grants the administer access to the settings for that particular message type. Options to be set for each type include:

enable this message type for group—makes the message type available to the group and patients of the group;

notify immediately—notifies the provider immediately upon receipt of this particular message type. Additionally, the administrator can specify an alternate address where notification is to be sent;

response time—displayed to the patient when the patient selects that message type; and

routing—options include a specific provider or staff member, or to the group inbox.

In addition to the message routing just described, messages can also be routed on an ad hoc basis. For example, if a provider receives an online consultation from a patient, the provider may route the record to another provider for a second opinion.

Additionally, an embodiment of the invention is possible, wherein patient messages are provided with an attached control that allows that status of the message to be set; for example a dropdown menu with values such as:

Open (default for unanswered messages) when message status is set to this value, the user may not archive the message if it has not been replied to.

Pending;

Resolved phone call with patient;

Resolved patient seen in office;

Resolved unable to contact patient;

Resolved other resolution;

Resolved reply sent—read only status that is set automatically when a reply is sent.

Broadcast Information

The system allows the provider to send timely health information in the form of newsletters 3601 and targeted preventive care messages 3602 to their patients.

Options for newsletters include:

edit newsletters—view articles in each month's newsletter and edit them 3603;

browse the article library—see what content is available 3604;

change newsletter options—change options for newsletter delivery 3605; get statistics—run a report for previously published newsletter 3606; and

view newsletter 3607.

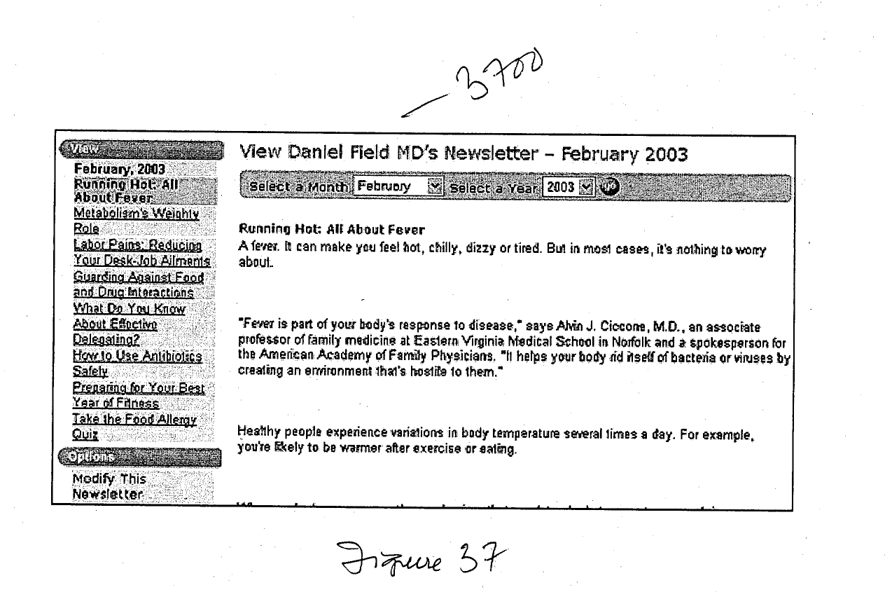

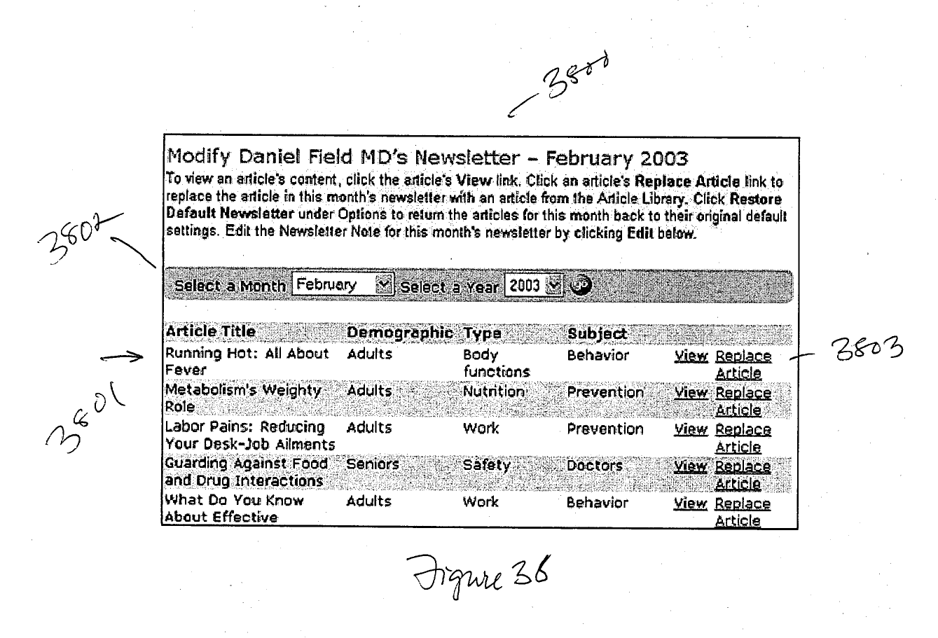

FIG. 37 shows a view 3700 of a provider newsletter. FIG. 38 illustrates a screen 3800 for editing a provider newsletter. Dropdown menus 3802 allow the provider to select a particular newsletter by month and year. A listing of the article titles for the issue selected is displayed. Links 3803 are provided for viewing and/or replacing the article. Thus, the provider, if a particular issue doesn't meet their needs, or the needs of their patients, could create a unique, completely customized information product.

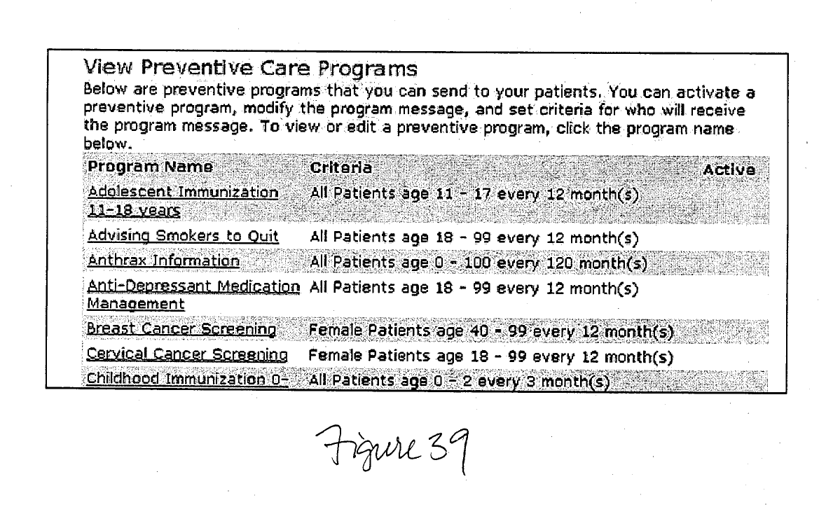

As FIG. 39 shows, the system provides a series of preventive health care programs for common health problems and topics, for example:

cholesterol screening;

anthrax information; or

breast cancer screening.

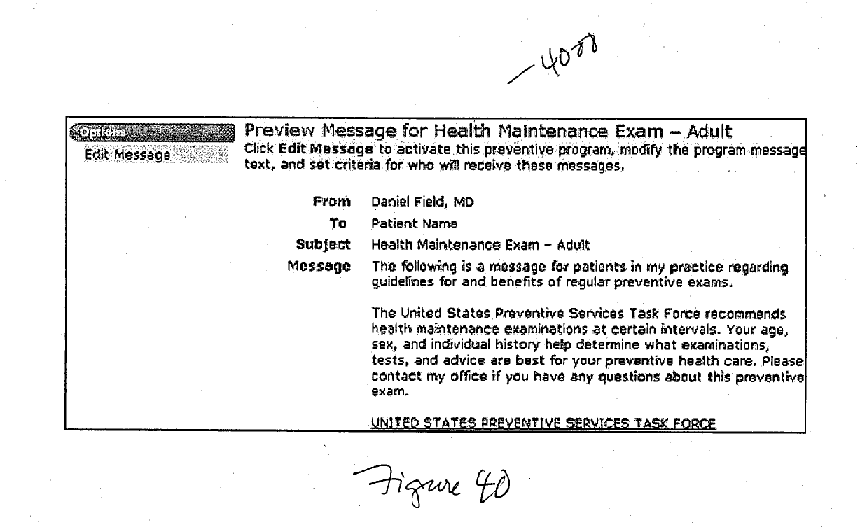

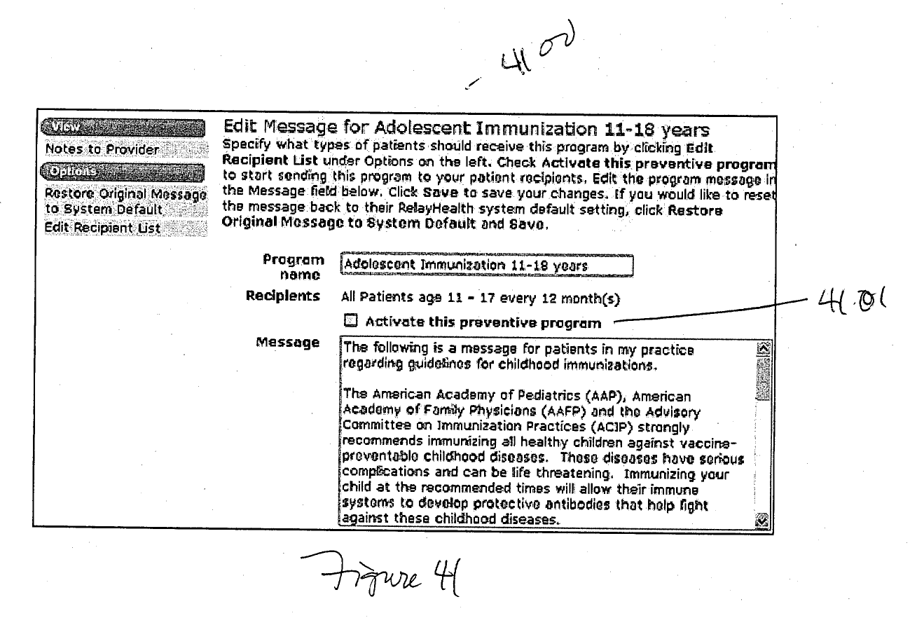

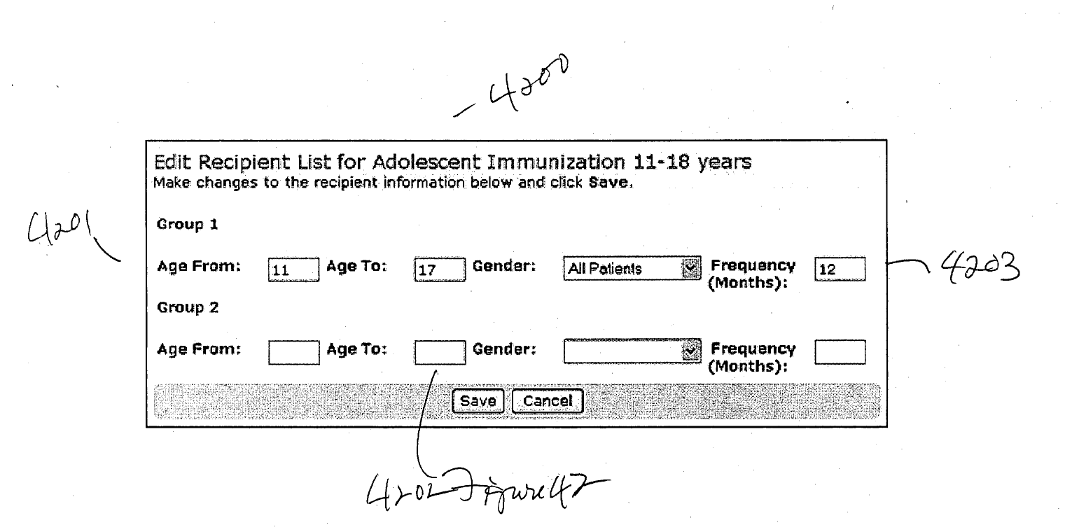

Providers can activate a particular program, edit the message as they see fit, and establish criteria for a targeted group of recipients. FIG. 40 provides a preview message showing how the message appears to the patient. An address header is inserted that includes the recipient name, and identifying the message as coming from the provider. FIG. 41 shows a screen 4100 for editing the message. After editing, a checkbox 4101 allows the provider to activate the program. FIG. 42 shows a screen 4200 for establishing delivery criteria. Dropdown menus are provided for specifying age range 4201, gender 4202 and frequency of distribution 4203. Additionally, criteria may be specified for more than one group.

In an alternate embodiment of the invention, the patient profile questions support the clinical logic to trigger a preventive program. As fields are populated with data, the system tracks the responses and pushes content based on algorithms that provide boundaries for inclusion and exclusion of data sets. Thus, the actions and behaviors of the system can be driven without any effort from the provider and push preventive care instructions automatically.

The provider also has the option of making a library of self-care articles accessible to their patients. When this option is activated, links to the self-care articles appear on the provider web site, and also in the patient's message center. As described previously, the provider may also furnish one or more self-care articles as attachments when responding to an online consultation.

Audit Trail

The HIPPA (Health Insurance Portability and Accountability Act of 1996) Privacy rule establishes standards to protect the confidentiality of individually identifiable health information maintained or transmitted electronically. In keeping with HIPPA requirements, the invention provides the capability of keeping an audit trail.

Essentially the audit trail tracks necessary data in order to always be able to answer the question “Who did what, and when?” At a minimum, the audit trail requires tracking:

Patient name or the user name established by the patient;

Action taken; and

Date/time of the action.

The audit trail is described in greater detail below, with respect to various functional areas of the communication system.

Patient Chart Auditing

The audit trail tracks entries of new information and modifications to current information in the patient profile, and date/time stamps each session. Web visit sessions are stored along with an association to the diagnosis and/or problem. Modifications to the patient chart profile that are not related to a web visit are classified as ‘other for auditing purposes.

Each area of the patient chart profile is modified to contain the last edited data for every piece of data, tracking (time/stamping), the date/time the information was last modified or deleted, including the action taken (e.g. ‘added,’ ‘modified,’ or deleted). When information is changed, the current version of the data is displayed.

The audit capability allows providers to view a list of actions taken in the clinical areas of the patient chart profile by the patient and other providers. All actions taken by all users, both patient and provider are tracked.

Actions to be audited:

View chart (without modification);

Add data;

Delete data;

Modify data; and

Approve chart.

Information to be tracked:

What information was changed;

Who changed it; and

When it was changed.

Chart areas to audit:

Problems;

Diagnoses;

Medications;

Allergies;

Pregnancy details;

Gynecological details

Doctor's notes; and

User interface and controls.

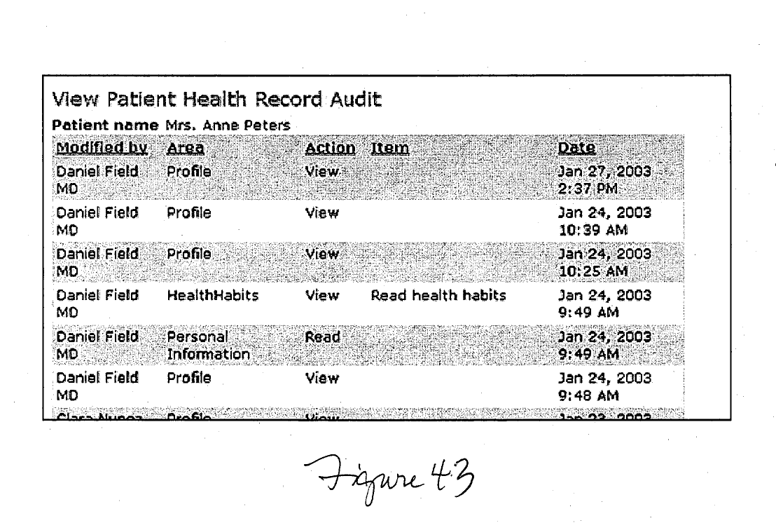

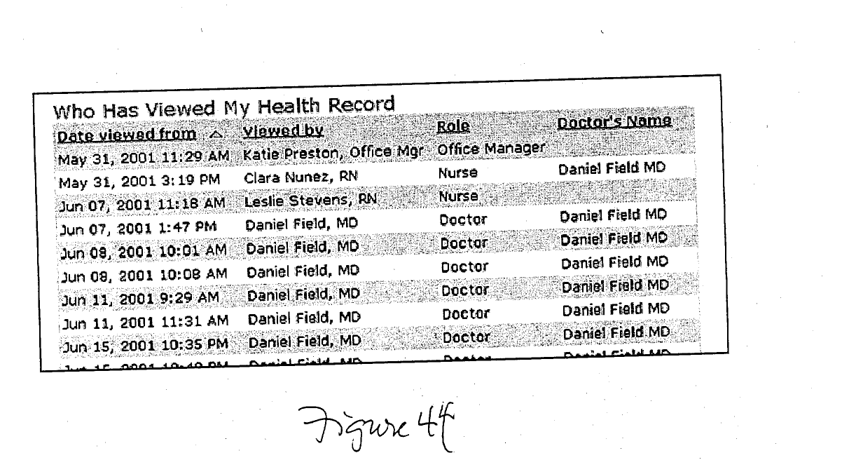

The provider view of the patient chart profile provides a link to an audit record. When clicked, the user is navigated to a screen that displays a results list with the audit data displayed in sortable columns, as in FIG. 43. A patient view of the health record audit is shown in FIG. 44.

Additionally, the audit record display screen includes controls for 1) navigating back to the patient information screen of the chart, 2) printing 3) filtering records and 4) advanced search that allows user to search audit record entries according to specified criteria.

Provider Auditing

When reviewing a web visit message in preparation for a response by a doctor, users on the doctor's office staff are able to update the patient's health profile, which in turn updates a face sheet, so that the doctor who eventually reads and responds to the message knows that the profile has been updated.

Updating the health profile also updates the date/time of the last office visit and the patient's chief complaint displayed in the face sheet.

A record of the following information is kept for each web visit and each update of the Health Profile/Face sheet:

Web visit session data;

Date/time the Health Profile/Face sheet was updated during the web visit. In logging the date/time, it is associated with the specific web visit. If the Health Profile is updated apart from a web visit, then it is logged as ‘Other;’ and

Health Profile fields that were updated.

While third parties may also be provided with message centers, as described above, the system also includes a fax module 123. Thus, messages can be delivered to third parties by fax also. For example, an embodiment of the invention is possible wherein a prescription or a renewal or refill request may be faxed to the pharmacy. Insurance inquiries may likewise be directed to payors by fax.

The foregoing description is meant to be illustrative only, and is not intended to limit the scope of the claimed Invention. The invention is implemented using conventional methods known to those skilled in the arts of data and telecommunication networking and computer programming. A variety of languages and protocols have been used in the exemplary implementation herein described, among them: ASP (active server pages) COM (component object model), SOAP (simple object access protocol), XML (extensible markup language), HTML (hypertext markup language) and NET (MICROSOFT CORPORATION, Redmond Wash.). However, other programming languages and approaches may be apparent to those having an ordinary level of skill; and are considered to fall within the scope of the invention.

Although the invention has been described herein with reference to certain preferred embodiments, one skilled in the art will readily appreciate that other applications may be substituted for those set forth herein without departing from the spirit and scope of the present invention. Accordingly, the invention should only be limited by the claims included below

1. A distributed system for managing communication among healthcare providers, patients and third parties comprising:
at least one server;
a plurality of clients in communication with said server at least intermittently;
program means embodied on said server for providing a plurality of specialized message types;
said providers, patients and third parties comprising users, wherein a selected message type is configured to facilitate a separate communication task among at least some of said users;
wherein users exchange messages by means of said clients.

2. The system of claim 1, wherein said tasks are specific to requirements of a healthcare environment.

3. The system of claim 1, wherein said server comprises any of:
a physical server; and
a logical server.

4. The system of claim 1, wherein said program means comprises a plurality of modules comprising any of:
a scripting engine;
an authentication module;
a message center module;
a provider web site module;
a patient profile module;
an administrative messaging module;
a clinical messaging module;
a newsletter module;
a self-care module;
a template engine;
a scripting engine;
a group monitor;
a billing module;
a proxy module;
an eligibility module;
a prescription engine;
an attachments server; and
a fax module.

5. The system of claim 4, wherein said scripting engine comprises means for processing scripts that invoke remaining modules from said plurality of said modules.

6. The system of claim 4, wherein said authentication module comprises means for authenticating users accessing said system from a partner in a single logon.

7. The system of claim 4, wherein said message center module comprises means for providing each user a message center for viewing and composing messages.

8. The system of claim 4, wherein said provider web site module comprises means for furnishing a web site for each provider.

9. The system of claim 4, wherein said provider web site module further comprises means for customizing and configuring said web site by said provider.

10. The system of claim 4, wherein said patient profile module comprises means for creating and maintaining a patient health profile.

11. The system of claim 10, wherein said audit module comprises means for monitoring accesses and modifications to said health profile, wherein a resulting audit record is viewable by said patient and said patient's provider.

12. The system of claim 4, wherein said administrative messaging module comprises means for composing and exchanging specialized messages related to administrative tasks.

13. The system of claim 12, wherein said administrative messaging module depends on structured message templates served by said template engine.

14. The system of claim 12, wherein specialized messages include any of
appointment requests;
responses to appointment requests,
confirmations;
appointment reminders;
billing inquiries;
responses to billing inquires;
insurance-related inquiries;
responses to insurance-related inquiries;
requests for referrals;
referrals; and
requests for prescription refills.

15. The system of claim 4, wherein said clinical messaging module comprises means for conducting an online consultation between patient and provider.

16. The system of claim 4, wherein said online consultation depends on a scripted interview adapted to a specific health issue, wherein a patient answers questions posed by said interview and a message is composed based on said patient's answers and sent to said provider.

17. The system of claim 16, wherein said means for conducting an online consultation includes means for said provider to reply to said message based on said patient's answers.

18. The system of claim 17, wherein said provider's reply includes any of:
treatment instructions;
an appointment reminder;
a report of lab/test results;
and attachments.

19. The system of claim 18, wherein said attachment engine is configured to attach any of:
files;
prescriptions;
scripted interviews;
self-care articles;
newsletter articles; and
web links
to said provider's reply.

20. The system of claim 4, wherein said clinical messaging module comprises means for composing and exchanging specialized messages related to clinical matters.

21. The system of claim 20, wherein said clinical messaging module depends on structured message templates served by said template engine.

22. The system of claim 20, wherein said specialized messages include any of:
requests for lab/test results;
reports of lab/test results;
requests for prescription renewals.

23. The system of claim 4, wherein said newsletter module comprises means for editing and publishing a provider newsletter.

24. The system of claim 4, wherein said self-care module comprises means for publishing a library of self-care articles.

25. The system of claim 4, said program means further comprising means for distributing preventive care programs to targeted groups of patients.

26. The system of claim 4, further comprising means for configuring settings for provider groups.

27. The system of claim 26, said means for configuring settings for provider groups further comprising means for configuring rights and privileges for individual group members.

28. The system of claim 4, said billing module comprising means for establishing fees for selected services and billing any of patient and provider for said services.

29. The system of claim 4, said eligibility module comprising means for determining a patient's eligibility for payor-coverage of fee-based services.

30. The system of claim 4, said prescription engine comprising means for composing prescriptions online and sending to a pharmacy.

31. The system of claim 4, said program means further comprising means for configuring message options and routing, wherein message options include response times for individual message types and routing comprises directing an individual message type to a selected member of a group.

32. The system of claim 4, wherein said proxy module comprises means for designating selected group members as message proxies and prescription proxies, wherein proxies are authorized to act on behalf of an intended recipient of a message.

33. The system of claim 32, wherein said group monitor comprises means for viewing status of messages for group members, wherein any of members, message proxies and prescription proxies take action on a message within a prescribed response time.

34. The system of claim 1, further comprising at least one data store in communication with said server.

35. A method of managing communication among healthcare providers, patients and third parties in a distributed system comprising steps of:
providing at least one server;
providing a plurality of clients in communication with said server at least intermittently;
providing program means embodied on said server for providing a plurality of specialized message types; and
exchanging messages by users by means of said clients, said providers, patients and third parties comprising said users;
wherein a selected message type is configured to facilitate a separate communication task among at least some of said users.

36. The method of claim 35, wherein said tasks are specific to requirements of a healthcare environment.

37. The method of claim 35, wherein said server comprises any of:
a physical server; and
a logical server.

38. The method of claim 35, wherein said step of providing said program means comprises a step of providing a plurality of modules comprising any of:
a scripting engine;
an authentication module;
a message center module;
a provider web site module;
a patient profile module;
an administrative messaging module;
a clinical messaging module;
a newsletter module;
a self-care module;
a template engine;
a scripting engine;
a group monitor;
a billing module;
a proxy module;
an eligibility module;
a prescription engine;
an attachments server; and
a fax module.

39. The method of claim 38, wherein said scripting engine comprises means for processing scripts that invoke remaining modules from said plurality of said modules.

40. The method of claim 38, wherein said authentication module comprises means for authenticating users accessing said system from a partner in a single logon.

41. The method of claim 38, wherein said message center module comprises means for providing each user a message center for viewing and composing messages.

42. The method of claim 38, wherein said provider web site module comprises means for furnishing a web site for each provider.

43. The method of claim 38, wherein said provider web site module further comprises means for customizing and configuring said web site by said provider.

44. The method of claim 38, wherein said patient profile module comprises means for creating and maintaining a patient health profile.

45. The method of claim 44, wherein said audit module comprises means for monitoring accesses and modifications to said health profile, wherein a resulting audit record is viewable by said patient and said patient's provider.

46. The method of claim 38, wherein said step of exchanging messages comprises exchanging specialized messages related to administrative tasks by means of said administrative messaging module.

47. The method of claim 46, wherein said administrative messaging module depends on structured message templates served by said template engine.

48. The method of claim 46, wherein the step of exchanging administrative messages comprises exchanging any of
appointment requests;
responses to appointment requests,
confirmations;
appointment reminders;
billing inquiries;
responses to billing inquires;
insurance-related inquiries;
responses to insurance-related inquiries;
requests for referrals;
referrals; and
requests for prescription refills.

49. The method of claim 38, wherein the step of exchanging messages comprises conducting an online consultation between patient and provider by means of said clinical messaging module.

50. The method of claim 38, wherein the step of conducting an online consultation comprises:
said patient answering questions posed by a scripted interview adapted to a specific health concern;
composing a message based on said patient's answers; and
sending said message to said provider.

51. The method of claim 50, wherein conducting said online consultation includes replying to said message by said provider based on said patient's answers.

52. The method of claim 51, wherein said step of replying includes any of:
providing treatment instructions;
providing an appointment reminder;
reporting lab/test results; and
providing attachments.

53. The method of claim 52, wherein providing attachments includes attaching any of:
files;
prescriptions;
scripted interviews;
self-care articles;
newsletter articles; and
web links to said provider's reply;
wherein said attachment engine is configured to provide said attachments.

54. The method of claim 38, wherein said step of exchanging messages comprises exchanging specialized messages related to clinical matters by means of said clinical messaging module.

55. The method of claim 38, wherein said clinical messaging module depends on structured message templates served by said template engine.

56. The method of claim 54, wherein said step of exchanging messages related to clinical matters comprises exchanging any of:
requests for lab/test results;
reports of lab/test results; and
requests for prescription renewals.

57. The method of claim 38, further comprising a step of editing and publishing a provider newsletter by means of said newsletter module.

58. The method of claim 38, further comprising a step of publishing a library of self-care articles by means of said self-care module.

59. The method of claim 38, further comprising a step of distributing preventive care programs to targeted groups of patients.

60. The method of claim 38, further comprising a step of configuring settings for provider groups.

61. The method of claim 60, further comprising a step of configuring rights and privileges for individual group members.

62. The method of claim 38, further comprising a step of establishing fees for selected services and billing any of patient and provider for said services by means of said billing module.

63. The method of claim 38, further comprising a step of determining a patient's eligibility for payor-coverage of fee-based services by means of said eligibility module.

64. The method of claim 38, further comprising a step of:
composing prescriptions online; and
sending to a pharmacy by means of said prescription engine.

65. The method of claim 38, further comprising a step of configuring message options and routing, wherein message options include response times for individual message types and routing comprises directing an individual message type to a selected member of a group.

66. The method of claim 38, further comprising a step of designating selected group members as message proxies and prescription proxies by means of said proxy module, wherein proxies are authorized to act on behalf of an intended recipient of a message.

67. The method of claim 66, further comprising the step of:
determining status of messages for members of a group and taking action on a message by any of group members, message proxies and prescription proxies within a prescribed response time by means of said group monitor.

68. The method of claim 35, further comprising a step of providing at least one data store in communication with said server.
